(19) United States
(12) Patent Application Publication
(10) Pub. No.: US 2026/0288830 A1
(43) Pub. Date: Sep. 24, 2026

(54) SYSTEM

(71) Applicant: SoftBank Group Corp., Tokyo (JP)

(72) Inventor: Keyaki ISHIWATARI, Tokyo (JP)

(73) Assignee: SoftBank Group Corp., Tokyo (JP)

(21) Appl. No.: 19/561,833

(22) Filed: Mar. 10, 2026

(30) Foreign Application Priority Data
Mar. 19, 2025 (JP) 2025-044989

(51) Int. Cl. G06F 16/334; G06F 40/211; G06F 40/226; G06F 40/284; G06F 40/295; G06F 40/40; G06N 3/0475; G10L 15/187; G10L 25/63

(52) U.S. Cl. CPC G06F 16/3344; G06F 40/211; G06F 40/226; G06F 40/284; G06F 40/295; G06F 40/40; G06N 3/0475; G10L 15/187; G10L 25/63

(57) ABSTRACT

A system includes a processor configured to: receive a data definition instruction via voice input, convert the user's voice to a digital signal, apply speech recognition and natural language processing to convert the voice data into text data; analyze the converted text data as a prompt for generating a database query, input the prompt to a generative AI model, and generate a corresponding SQL query; transmit the SQL query to a data warehouse query engine for execution; analyze emotional features extracted from the voice input to recognize user emotion and provide feedback to the generative AI model to adjust query generation accordingly; and return the execution result to the user visually or auditorily.

### CROSS-REFERENCE TO RELATED APPLICATION

This application is based on and claims priority under 35 USC 119 from Japanese Patent Application No. 2025-044989 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for querying large-scale databases and data warehouses generally require users to possess specialized knowledge of query languages such as SQL and to understand the underlying database schema. As a result, non-technical users face significant difficulty in directly obtaining desired analytical results, and must rely on data engineers or analysts, which leads to increased communication cost, time delay, and risk of misinterpretation of user intent. Furthermore, in systems that accept natural language or voice input, existing approaches often do not fully leverage emotional information contained in the user's voice, and therefore fail to adapt the query generation process to the user's emotional state, such as confusion, frustration, or uncertainty. This may result in queries that do not accurately reflect the user's real needs, as well as a degraded user experience. In addition, known systems frequently treat speech recognition, natural language understanding, and query generation as loosely connected components, without an integrated feedback mechanism from detected emotional features back to the generative model, which limits the precision and flexibility of the generated queries. Therefore, there is a need for a system that enables a user to define and execute database queries using natural language voice input, without requiring expertise in SQL, and that recognizes and utilizes the user's emotional information to dynamically adjust and improve the query generation process, thereby providing query results that more accurately match the user's intent and enhancing the overall interaction with the data warehouse.

### SUMMARY

In order to solve the above-described problems, a system is provided comprising a processor configured to receive a data definition instruction given by a user via voice and convert a voice of the user into a digital signal by using a voice input device. The processor is further configured to convert received voice data into text data by using a natural language processing technique and apply a speech recognition algorithm to convert a voice signal into a character string. The processor is also configured to analyze the converted text data and use the converted text data as a prompt for generating a database query, input the prompt to a generative AI model, and generate a corresponding SQL query. The processor is configured to execute the generated database query in a data warehouse by transmitting the SQL query to a query engine of the data warehouse and causing the query to be executed. In addition, the processor is configured to recognize emotion information of the user and adjust generation of the database query based on the emotion information by analyzing emotional features extracted from the voice input and providing feedback to the generative AI model to adjust query generation. The processor is further configured to return an execution result to the user by presenting to the user, visually or auditorily, a result obtained from the data warehouse. In one aspect, the processor is configured to analyze a data definition instruction from the user by a natural language understanding technique, and use the analyzed instruction as a prompt for generating the database query, input the prompt to the generative AI model, and generate the corresponding SQL query. In another aspect, the processor is configured to receive the voice input from the user and convert the voice of the user into the digital signal by using the voice input device. Through these configurations, the system enables intuitive, natural language-based query definition and execution, while dynamically adapting query generation to the user's emotional state, thereby improving both the accuracy of generated SQL queries and the quality of user interaction with the data warehouse.

The term “processor” refers to a hardware or virtual computing element, such as a central processing unit (CPU), graphics processing unit (GPU), application-specific integrated circuit (ASIC), field-programmable gate array (FPGA), or a combination thereof, capable of executing instructions to perform the functions described in the claims.

The term “data definition instruction” refers to information expressed by a user, in natural language or another human-understandable form, that specifies a request for retrieval, aggregation, analysis, or presentation of data stored in a database or data warehouse, and that serves as a basis for generating a database query.

The term “voice input device” refers to a device configured to acquire a user's voice, such as a microphone or an array of microphones integrated into a terminal or a peripheral device, and to output a corresponding analog or digital audio signal.

The term “digital signal” refers to an electrical or logical representation of audio information in discrete time and quantized amplitude form, such as pulse code modulation (PCM) data, that can be processed by the processor.

The term “voice data” refers to digital audio data that represents the user's spoken utterance, obtained by sampling and encoding the user's voice through the voice input device.

The term “natural language processing technique” refers to a computational technique or algorithm for processing human language, including tasks such as tokenization, part-of-speech tagging, syntactic parsing, semantic analysis, or other operations that convert unstructured text or speech into structured representations.

The term “text data” refers to a sequence of characters or symbols, expressed in a written language such as Japanese or English, that results from converting voice data or other input into textual form.

The term “speech recognition algorithm” refers to a computational method or model, such as a hidden Markov model, deep neural network, or end-to-end acoustic-linguistic model, configured to convert an audio signal representing speech into a sequence of text characters or words.

The term “character string” refers to an ordered sequence of characters, such as letters, digits, punctuation marks, or other symbols, representing the textual content of the user's utterance.

The term “prompt” refers to input information provided to a generative AI model, including at least the converted or analyzed text data derived from the user's data definition instruction, and optionally additional context or constraints, for causing the model to generate a database query.

The term “database query” refers to a request expressed in a formal query language, such as SQL, for retrieving, aggregating, filtering, or otherwise manipulating data stored in a database or data warehouse.

The term “generative AI model” refers to a machine learning model, such as a large language model or another generative model, trained on data to generate text or other outputs in response to input prompts, and configured to generate database queries corresponding to user instructions.

The term “SQL query” refers to a database query expressed in Structured Query Language (SQL) or a dialect thereof, including statements such as SELECT, WHERE, GROUP BY, ORDER BY, and related clauses for specifying data retrieval or analysis.

The term “data warehouse” refers to a data storage and management system, typically optimized for analytical processing and large-scale data retrieval, that stores integrated data from one or more sources and executes database queries via a query engine.

The term “query engine” refers to a component or subsystem of the data warehouse configured to receive database queries, optimize and plan their execution, access the underlying data storage, and return result sets corresponding to the queries.

The term “emotion information” refers to information indicating an emotional state or attitude of the user, such as satisfaction, frustration, confusion, confidence, or urgency, inferred from features of the user's voice, lexical content, prosody, or other indicators.

The term “emotional features” refers to measurable or computable attributes derived from the user's voice or text, such as pitch, volume, speech rate, intonation patterns, lexical choices, or paralinguistic signals, that are used to infer the user's emotion information.

The term “feedback” refers to information provided from the processor to the generative AI model, based on the recognized emotion information or other contextual factors, for influencing or adjusting the behavior of the model when generating a database query.

The term “execution result” refers to data or information returned from the data warehouse in response to execution of the SQL query, including result sets, aggregated values, or other outputs produced by the query engine.

The term “visually or auditorily presenting” refers to outputting information to the user via one or more user interfaces, including displaying text, tables, charts, or graphics on a screen, or outputting synthesized speech or other audio signals through speakers or headphones.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

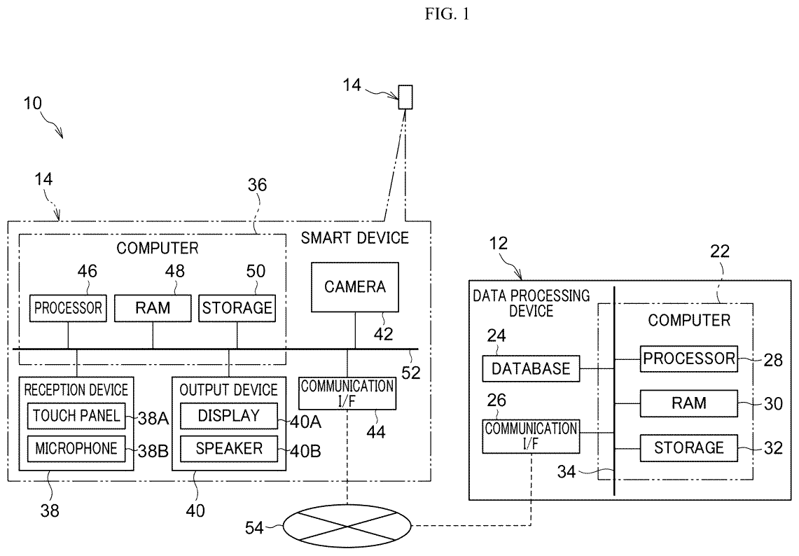

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

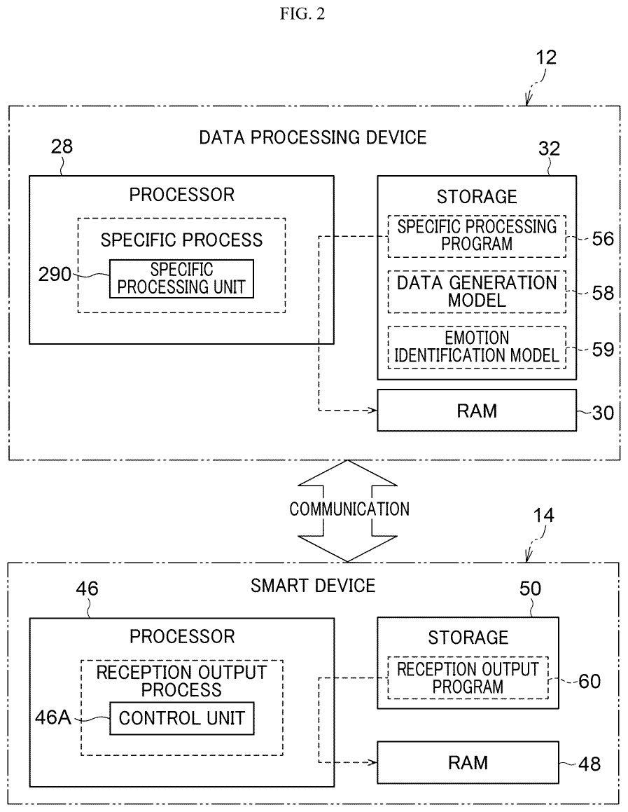

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional data access systems that rely on natural language interfaces suffer from several technical shortcomings when implemented on general-purpose computing hardware. First, when a user issues a voice-based request, existing systems often perform a simple speech-to-text conversion and then apply a set of hand-crafted rules or templates to generate a database query. Such rule-based pipelines are brittle, frequently produce syntactically invalid or semantically inappropriate queries, and do not scale well to complex schemas or evolving data structures. As a result, the computing resources of the server are inefficiently used, with repeated query failures, unnecessary round trips to the database engine, and redundant processing steps.

Second, systems that directly apply a generative AI model to natural language instructions typically treat the model as a black box and pass user text directly as a prompt. Without explicit incorporation of schema information, safety checks, and normalization within the query-generation pipeline, the generated query can include prohibited operations, reference non-existent objects, or trigger inefficient execution plans. These failures increase CPU and memory load on the database engine, cause timeouts and locks, and degrade overall system throughput and latency.

Third, many known systems ignore user emotional state embedded in the voice signal. When the system misinterprets a request or produces an unsatisfactory result, the system continues to behave in the same way, without adjusting the level of detail, the strictness of safety controls, or the clarification behavior. This lack of adaptation leads to additional corrective interactions, which in turn cause more processing cycles, additional invocations of the generative AI model, and unnecessary database queries, thereby reducing the efficiency and robustness of the overall computer system.

Fourth, typical user interfaces for natural language querying fail to present the relationship among (i) the original user instruction, (ii) the generated database query, and (iii) the returned result in an integrated manner. The user cannot easily understand how the system interpreted the request, and when the user attempts to refine the query, the system often treats the new input as an entirely independent request. As a consequence, the server must repeatedly recompute prompt context and regenerate queries from scratch, instead of leveraging a structured interaction history, leading to redundant computation and suboptimal use of processing resources.

Therefore, there is a need for a technical solution that, on standard server hardware, (i) couples speech recognition and natural language understanding with a structured prompt generation mechanism, (ii) tightly integrates a generative AI model with schema-aware validation and normalization, (iii) utilizes emotion-related features extracted from the voice signal to adapt query generation behavior, and (iv) manages an interactive feedback loop in which display content and additional user input are systematically reused. Such a solution should improve the reliability, safety, and efficiency of query generation and execution at the level of the computer system itself, rather than merely providing an abstract automation of human tasks.

The specific processing by the specific processing unit 290 of the data processing device 12 in Example 1 is realized by the following means.

The present invention provides a server comprising a processor configured to receive an information acquisition request in the form of speech from a user, convert a voice signal from the user into a discrete numerical signal by using an audio input apparatus, and apply speech recognition processing based on natural language processing techniques to transform the discrete numerical signal into character-string information; generate a prompt sentence based on the character-string information and data structure information stored in a storage apparatus, the prompt sentence being arranged to instruct a generative AI model to produce a data inquiry command; input the prompt sentence into the generative AI model and obtain, from the generative AI model, an inquiry statement including the data inquiry command corresponding to the character-string information; inspect the inquiry statement to detect existence of prohibited commands and to verify consistency of referenced data objects with the data structure information, and normalize the inquiry statement based on a result of the inspection; transmit the normalized inquiry statement to a query processing mechanism of a data accumulation apparatus and cause the query processing mechanism to execute the normalized inquiry statement to perform aggregation processing or search processing; analyze a processing result returned from the data accumulation apparatus and convert the processing result into tabular information or a graph display structure suitable for presentation on a display apparatus; control transmission of the converted processing result, together with at least part of the character-string information and the data inquiry command, to the display apparatus so that the display apparatus presents the converted processing result as visual information; and analyze emotional feature quantities extracted from the speech of the user and, based on the emotional feature quantities, adjust content of the prompt sentence or generation conditions used by the generative AI model when generating the inquiry statement. This enables the server to implement, on general-purpose computing hardware, a technically improved natural language query pipeline that (i) reliably converts voice input into safe and schema-consistent database queries through schema-aware prompt construction, generative AI model interaction, and post-generation validation, (ii) adapts query generation behavior to user emotional state to reduce corrective interactions and redundant invocations of computation components, and (iii) maintains an interactive feedback loop in which combined display of user instructions, generated queries, and results allows efficient refinement of subsequent prompts, thereby improving overall system throughput, latency, and robustness relative to conventional natural language data access systems.

The term “information acquisition request” refers to a user-issued instruction, expressed in speech or character information, that specifies data to be retrieved, aggregated, or otherwise queried from one or more data storage resources.

The term “speech” refers to an acoustic signal produced by a user and captured by an audio input apparatus, representing spoken natural language utterances.

The term “audio input apparatus” refers to hardware and associated low-level software that capture an analog audio signal from a user and convert the analog audio signal into a discrete numerical signal suitable for digital processing, such as a microphone in combination with an audio interface.

The term “discrete numerical signal” refers to a time-series representation of an audio waveform obtained by sampling and quantizing an analog signal, such as pulse-code modulated data, that is processable by digital signal processing and machine learning algorithms.

The term “communication path” refers to a logical or physical data transmission channel between components of the system, such as a wired or wireless data network, over which numerical signals, character strings, commands, and results are transmitted.

The term “processing apparatus” refers to one or more computing units, including a processor, memory, and associated system components, configured to execute software instructions implementing speech recognition, natural language processing, prompt generation, query generation, and result formatting.

The term “speech recognition processing” refers to a sequence of computational operations that transform a discrete numerical signal representing speech into character-string information, using acoustic models, language models, or other machine learning or rule-based techniques.

The term “natural language processing technology” refers to a set of algorithms and models for analyzing, understanding, and transforming human language expressed in text or speech, including tokenization, syntactic analysis, semantic analysis, and related operations.

The term “character-string information” refers to textual data represented as a sequence of characters or tokens, obtained by converting user speech or input text into a digital text form interpretable by software components.

The term “data structure information” refers to metadata describing organization of stored data, including names of data containers, attribute names, data types, relationships, and constraints used for query construction and validation.

The term “prompt sentence” refers to a structured textual instruction, possibly including schema information, constraints, and user intent, that is provided as input to a generative AI model to control generation of a data inquiry command or related output.

The term “generative AI model” refers to a machine learning model configured to generate text outputs, such as natural language or query language statements, in response to input prompt sentences, based on parameters learned from training data.

The term “data inquiry command” refers to a formal expression, such as a query language clause, that specifies conditions for retrieval, aggregation, or filtering of data stored in a data storage resource.

The term “inquiry statement” refers to a complete query expression, including at least one data inquiry command, written in a query language and executable by a query processing mechanism of a data accumulation apparatus.

The term “prohibited command” refers to a portion of an inquiry statement that is designated as disallowed in a given execution context, such as commands that modify or delete stored data or change structural definitions of data.

The term “reference target” refers to an object or element referenced in an inquiry statement, including but not limited to data containers, attributes, views, or functions that are defined in the data structure information.

The term “normalize the inquiry statement” refers to modifying an inquiry statement, based on inspection results, to satisfy pre-defined syntactic, semantic, or safety constraints, including removal of prohibited commands, correction of inconsistent references, and adjustment of formatting.

The term “data accumulation apparatus” refers to one or more devices or systems that store data persistently and provide a query processing mechanism, such as a database system, data warehouse system, or similar storage and query engine.

The term “query processing mechanism” refers to software and associated components that receive an inquiry statement, parse and analyze it, generate an execution plan, access stored data, perform aggregation or search operations, and return a processing result.

The term “aggregation processing” refers to operations that compute summary values from multiple records, such as sums, averages, counts, or other aggregate functions, in response to a data inquiry command.

The term “search processing” refers to operations that locate and return data records satisfying specified conditions or patterns defined in an inquiry statement.

The term “processing result” refers to data produced by execution of an inquiry statement by the query processing mechanism, including raw records, aggregated values, or intermediate outputs prepared for presentation.

The term “tabular information” refers to a representation of a processing result organized into rows and columns, suitable for display in table form on a display apparatus.

The term “graph display structure” refers to a data structure describing visual elements for graphical representation of a processing result, such as axes, labels, series, and data points for charts and graphs.

The term “display apparatus” refers to hardware and associated user interface software that present visual information to a user, such as a display panel, terminal device, or graphical user interface.

The term “visual information” refers to information encoded in a form suitable for presentation on a display apparatus, including tables, charts, text annotations, and other graphical elements.

The term “emotional feature quantities” refers to numerical or categorical indicators derived from analysis of a user's speech signal or related data, representing aspects of the user's emotional state such as sentiment, intensity, or stress level.

The term “generation conditions” refers to parameters, constraints, or contextual inputs supplied to a generative AI model that influence how the model produces an inquiry statement, including but not limited to instructions regarding safety, level of detail, style, or optimization goals.

In one embodiment, a server cooperates with a terminal and a user to implement a natural-language-based data inquiry system that converts voice or text instructions into validated database queries and structured visual results. The server includes at least one processor, a memory, a network interface, and access to a data accumulation apparatus such as a database system or a data warehouse. The terminal includes an audio input apparatus such as a microphone, a display apparatus such as a display panel, and a user interface module implemented as a web application or a native mobile application.

The terminal uses an operating system audio input API, such as an audio capture interface provided by a mobile operating system or a browser audio interface, to sample an analog speech signal from the user and to convert the analog speech signal into a discrete numerical signal. The terminal uses a communication protocol, such as a secure transport protocol, to transmit the numerical signal and associated metadata (sampling rate, language, session identifier) to the server.

The server stores executable instructions in the memory that cause the processor to perform a sequence of data-processing operations. The server uses a speech recognition component that may be implemented by a deep neural network-based acoustic model and language model executing on a general-purpose processor or a graphics processing unit. The server applies spectral analysis, such as short-time Fourier transform or mel-frequency cepstral coefficient extraction, to the discrete numerical signal, and then inputs the resulting feature vectors into a trained neural network model configured for automatic speech recognition. The neural network may have an encoder-decoder architecture, such as a recurrent neural network with attention or a transformer-based architecture, trained using a connectionist temporal classification loss or a sequence-to-sequence loss. The server thereby converts the speech features into character-string information that represents the user's natural language utterance.

The server stores data structure information describing at least one data table or other data container maintained by the data accumulation apparatus. The data structure information may include table names, column names, data types, constraints, and relationships. The server retrieves relevant schema elements based on the context of the user's request, such as identifying that the “sales” domain is associated with a table having attributes including a date attribute and a numeric amount attribute.

The server generates a prompt sentence by combining the character-string information with the data structure information and system-level instructions for query generation. The server concatenates fixed instruction text, schema description text, and the recognized user utterance into a structured natural language input for a generative AI model. The generative AI model may be implemented by a parameterized neural network, such as a transformer-based language model trained on large text corpora, that maps sequences of tokens representing the prompt sentence to sequences of tokens representing a query language expression.

The server uses tokenization to convert the prompt sentence into a sequence of token identifiers and transmits the sequence to the generative AI model. The generative AI model performs multi-head self-attention and feedforward operations layer by layer, using stored parameter matrices that have been trained by gradient-based optimization methods such as stochastic gradient descent or an adaptive variant with backpropagation of error through the network. The generative AI model applies a language modeling objective during training, such as minimizing a cross-entropy loss between predicted and actual next tokens, and uses techniques such as positional encoding, dropout regularization, and layer normalization to stabilize training. During inference, the generative AI model uses a decoding algorithm such as greedy decoding or beam search to produce an inquiry statement including at least one data inquiry command, such as a structured query language statement.

The server receives the generated inquiry statement and applies a rule-based validation and normalization process. The server parses the inquiry statement into an abstract syntax representation by applying a query grammar. The server scans the parsed representation for prohibited commands, such as data definition commands or data modification commands that are not allowed in the context of the system. The server compares referenced table names, column names, and functions against the stored data structure information to detect inconsistencies, such as references to non-existent objects. The server removes or replaces disallowed clauses, adjusts aliases, and standardizes formatting according to predetermined normalization rules. By enforcing these constraints at the server side, the system prevents the data accumulation apparatus from executing harmful or inefficient queries and ensures that the generated query aligns with the actual schema.

The server uses a database driver to transmit the normalized inquiry statement to the query processing mechanism of the data accumulation apparatus. The data accumulation apparatus may be implemented by a relational database management system or a data warehouse system executing on dedicated server hardware or virtualized infrastructure. The query processing mechanism parses the received statement, optimizes an execution plan by selecting indexes and join strategies, and performs aggregation processing or search processing on stored data. The query processing mechanism returns a processing result to the server as a set of records, which the server receives via the database driver.

The server converts the processing result into tabular information or a graph display structure. The server maps fields in the result set to axes, labels, and data series definitions. For example, when the result includes a time-related attribute and an aggregated amount attribute, the server constructs a line chart structure, designating the time attribute as the horizontal axis and the aggregated amount as the vertical axis. The server may apply data transformation operations such as sorting, grouping, and type conversion using intermediate in-memory data structures. The server packages the visual structure along with the original character-string information and the normalized data inquiry command into a response message for the terminal.

The terminal receives the response message and uses a user interface framework to render the tabular information or graph display structure. The terminal draws the chart or table and concurrently displays the underlying data inquiry command and the textual form of the user's request. The user thus obtains a transparent view of how the system interpreted the natural language input and how the query relates to the returned result.

The server analyzes emotional feature quantities extracted from the speech of the user. The server uses the same discrete numerical signal or derived spectral features to compute prosodic and paralinguistic features, such as pitch contour, energy distribution, speaking rate, and spectral tilt. The server may also use an auxiliary classification model, such as a neural network trained on labeled emotion datasets, to map acoustic features to categorical or continuous emotion scores. The server stores these emotional feature quantities and uses them to adjust parameters of the prompt sentence generation and of the inference configuration for the generative AI model.

For example, when the server detects increased frustration or urgency based on elevated pitch variance and speech rate, the server modifies the prompt sentence to request more explicit, conservative, and confirmation-oriented query generation, and reduces the degree of query complexity permitted. The server may constrain the generative AI model by altering decoding parameters, such as reducing temperature or limiting maximum query length, and by adding explicit safety instructions to the prompt sentence. When the server detects a neutral or satisfied emotional state, the server allows more flexible query formulations and may include additional optimization hints in the prompt sentence. Because the server performs this adaptation based on measurable feature quantities and modifies concrete generation conditions, the system achieves a technical effect of reducing the number of failed or undesired queries and of lowering the computational load associated with repeated regeneration and re-execution.

In another embodiment, the user inputs an information acquisition request in the form of text through a keyboard or a touch-screen input interface on the terminal. The terminal transmits the textual input to the server without performing speech recognition. The server analyzes the character information by applying natural language understanding techniques, such as tokenization, part-of-speech tagging, dependency parsing, and intent classification. The server maps identified entities and intents to elements of the stored data structure information. The server generates the prompt sentence using the interpreted intent, the extracted entities, and the schema metadata, and then interacts with the generative AI model as in the voice-based embodiment. The server thus supports both speech and text modalities using the same schema-aware, safety-controlled query generation pipeline.

In another embodiment, the terminal displays the processing result, the data inquiry command, and the character-string information in a combined view. The user reviews the displayed result and issues an additional input, such as a refinement of the time period, a change in grouping level, or a filter on a category. The terminal sends this additional input as a new information acquisition request, while also indicating the previously executed inquiry context. The server incorporates the additional input into a new prompt sentence that references the prior query and the updated constraints, allowing the generative AI model to generate an incremental modification of the data inquiry command rather than an entirely new query. By reusing explicit context and structured prior information, the server reduces computational redundancy, improves query generation accuracy, and reduces the overall latency of successive interactions.

Concrete examples of prompt sentences used by the server include the following text forms:

You are an assistant that converts natural language data requests into SQL queries.

Table schema:
sales_table(month TEXT, sales INTEGER)

Natural language request:

“I want to know the monthly sales trend.”

Generate a single SQL query for a relational database without explanation.

Another example of a prompt sentence is:

You are an SQL generator.

Table schema:
sales_table(month Text, Sales Integer)

Task:

Generate an SQL query to compare sales between last month and this month from sales_table(month, sales).

Return only the SQL.

In a further example involving date attributes, the server uses a prompt sentence such as:

You are an assistant that converts natural language into SQL.

Table: sales_table(sale_date DATE, sales_amount NUMERIC)

Natural language:

“I want to know the monthly sales trend for the last 12 months.”

Generate a single SQL query for a relational database.

These prompt sentences encode not only the user's natural language request but also explicit schema definitions and operational constraints, which the generative AI model uses to generate structurally valid and semantically appropriate queries. By systematically constructing such prompt sentences on the server side, the system reduces ambiguity and improves the mapping from language to database operations.

The server implements the generative AI model using a neural network architecture that includes an input embedding layer, multiple self-attention layers, and an output softmax layer. The server trains or adapts the model using training data that contain pairs of natural language instructions and corresponding database queries, as well as schema descriptions. During training, the server uses a loss function such as token-level cross-entropy and updates weight parameters using gradient-based optimization. The server may apply data augmentation strategies, such as paraphrasing natural language inputs or randomly masking tokens in query templates, to increase robustness. The server may fine-tune a pre-trained language model on domain-specific data to improve accuracy for a given application.

The technical effect of the described configuration is that the server reduces the number of syntactically invalid or semantically incorrect queries that reach the data accumulation apparatus, thus reducing wasted CPU cycles and I/O operations at the query processing mechanism. The server also reduces communication overhead by avoiding repeated query retries and by transmitting only normalized and validated statements. Because the server integrates schema-aware validation, emotional feature-based adaptation, and interactive context reuse, the server improves the efficiency and reliability of operation compared to systems that simply run a generative AI model on raw text prompts.

In another embodiment, the server uses different types of generative AI models, such as smaller parameter models deployed locally for latency-sensitive requests and larger parameter models accessed through remote services for complex analytical queries. The server selects the model at runtime based on characteristics of the prompt sentence, the current system load, or the emotional feature quantities. By routing requests to appropriate models, the server balances performance and accuracy and further reduces average response time.

In another embodiment, the server stores the generated inquiry statements and corresponding prompt sentences, processing results, and emotional feature quantities in a log repository. The server uses these logs for offline analysis and retraining of models. The server can update normalization rules, prohibited command lists, and prompt templates based on observed error patterns. This feedback mechanism improves the underlying algorithms and thus enhances query generation accuracy and runtime efficiency over time.

The described embodiments are implemented through specific data structures, such as token sequences, abstract syntax trees, schema metadata tables, chart specification objects, and emotional feature vectors, and through specific algorithmic flows that combine speech processing, natural language understanding, generative modeling, rule-based validation, and visualization. Because these operations are executed in a coordinated manner on a server and terminal equipped with concrete hardware and software components, the system provides a technical improvement in computer-based query processing and data access rather than a mere automation of human decision-making.

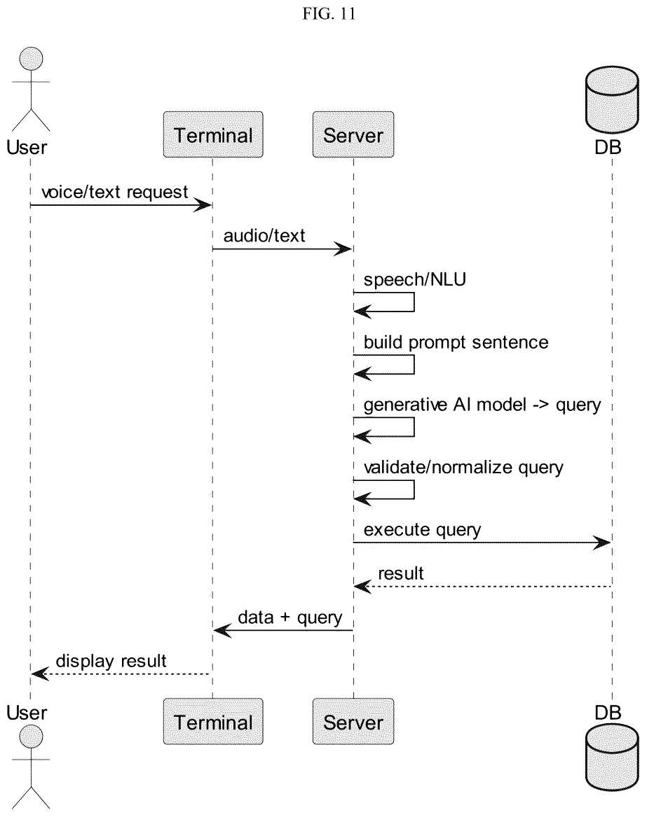

The following describes the processing flow using FIG. 11.

Step 1:

The user issues an information acquisition request.

The user speaks a natural language instruction, such as “I want to know the monthly sales trend for the last 12 months,” into a microphone connected to the terminal, or the user inputs an equivalent text instruction using a keyboard or a touch interface. The input of this step is a human natural language intention, expressed as acoustic speech or typed text. The output of this step is an analog audio signal or a text string captured at the terminal for further processing.

Step 2:

The terminal captures and digitizes the user's speech.

The terminal uses an audio input API to sample the analog audio signal from the microphone and converts the analog signal into a discrete numerical signal, for example, a pulse-code modulated sequence at a fixed sampling rate. The terminal may perform basic preprocessing, such as noise reduction or level normalization. The input of this step is the analog speech waveform from the user, and the output is a digital audio buffer containing numerical samples representing the speech, along with metadata such as sampling rate, language code, and session identifier.

Step 3:

The terminal transmits the digital audio and metadata to the server.

The terminal packages the digital audio buffer and its metadata into a request message and sends the request to the server through a secure communication channel. The terminal may compress the audio data into a standard format before transmission. The input of this step is the digital audio buffer and metadata stored in terminal memory, and the output is a network message that arrives at the server and is available for processing as a received request.

Step 4:

The server performs speech recognition to obtain character-string information.

The server reads the digital audio data and metadata from the received request and applies a speech recognition component that performs feature extraction and sequence modeling. The server converts the raw time-domain samples into feature vectors, such as mel-frequency cepstral coefficients or log-mel spectrogram frames, and then inputs these feature vectors into a trained neural network acoustic model combined with a language model. The server decodes the output of the neural network into a text transcription using algorithms such as beam search and language model scoring. The input of this step is the digital audio data and language metadata, and the output is character-string information that represents the user's spoken request as a text sentence.

Step 5:

The server generates an interpreted representation and identifies schema elements.

The server processes the character-string information with natural language understanding techniques, such as tokenization, part-of-speech tagging, and entity recognition, to determine intent and relevant entities like time ranges and measures. The server consults stored data structure information to map identified entities to specific tables and columns in the data accumulation apparatus. The input of this step is the character-string information from the speech recognition, and the output is an interpreted representation that includes an intent label, extracted parameters (for example, “time range=last 12 months”), and corresponding schema items (for example, table=sales_table, columns=sale_date, sales_amount).

Step 6:

The server constructs a prompt sentence for the generative AI model.

The server builds a structured natural language prompt by combining fixed instruction text, the schema description, and the interpreted user request. The server concatenates these components into a single text string, optionally inserting delimiters and headings. For example, the server constructs a prompt sentence such as:

“You are an assistant that converts natural language data requests into SQL queries.

Table schema:
sales_table(sale_date DATE, sales_amount NUMERIC)

Natural language request:

‘I want to know the monthly sales trend for the last 12 months.’

Generate a single SQL query for a relational database without explanation.”

The input of this step is the interpreted representation and the data structure information, and the output is the prompt sentence text that is suitable for input to the generative AI model.

Step 7:

The server extracts emotional feature quantities from the user's speech and adjusts generation conditions.

The server reuses the digital audio data or its derived features to compute acoustic descriptors, such as pitch statistics, energy levels, speaking rate, and spectral characteristics. The server feeds these descriptors into an emotion classification model, for example, a neural network trained to output emotion scores or categories. Based on the resulting emotional feature quantities, the server adjusts prompt construction parameters and generative model decoding settings, such as adding cautionary instructions to the prompt or reducing temperature and maximum query length. The input of this step is the digital audio data and previously computed features, and the output is a set of adjusted generation conditions that influence how the prompt sentence is formed and how the generative AI model is invoked.

Step 8:

The server invokes the generative AI model with the prompt sentence.

The server tokenizes the prompt sentence into token identifiers according to the vocabulary of the generative AI model, and it sends the sequence of token identifiers and generation parameters to the model runtime. The generative AI model processes the token sequence through multiple layers of self-attention and feedforward computation, using stored weight parameters that were learned during training. The server uses a decoding method such as greedy decoding or beam search, controlled by the adjusted generation conditions, to obtain a sequence of tokens that form an inquiry statement. The input of this step is the prompt sentence and generation parameters, and the output is a text string representing the inquiry statement, including at least one data inquiry command.

Step 9:

The server parses and validates the generated inquiry statement.

The server uses a query parser to convert the generated inquiry statement into an internal structured form, such as an abstract syntax tree. The server traverses this structure to detect prohibited commands, such as destructive data modification operations, and to confirm that all referenced tables, columns, and functions exist in the known schema. If any disallowed elements or inconsistencies are found, the server removes or replaces them according to predefined normalization rules, and may regenerate specific clauses when needed. The input of this step is the generated inquiry statement from the generative AI model, and the output is a normalized and validated inquiry statement that is syntactically correct and consistent with the schema.

Step 10:

The server sends the normalized inquiry statement to the data accumulation apparatus and executes it.

The server opens or reuses a database connection and submits the normalized inquiry statement to the query processing mechanism of the data accumulation apparatus. The query processing mechanism parses the statement, optimizes an execution plan, and reads or aggregates data stored on physical storage devices. The input of this step is the normalized query string and database connection information, and the output is a processing result in the form of tabular data returned from the data accumulation apparatus to the server.

Step 11:

The server transforms the processing result into tabular information or a graph display structure.

The server converts the raw result records into an internal data structure, such as an array of rows or an in-memory table. The server decides an appropriate visualization form based on the data fields, such as selecting a line chart for time series or a bar chart for category comparisons. The server assigns specific result fields to axes and series and constructs a graph specification that contains labels, scales, and data points. The input of this step is the processing result from the data accumulation apparatus, and the output is a formatted representation consisting of tabular information and, when applicable, a graph display structure ready for rendering.

Step 12:

The server bundles the interpretation context and sends it to the terminal.

The server composes a response that includes the tabular information or graph specification, the normalized data inquiry command, and the character-string information representing the original request or its refined form. The server may include additional metadata, such as execution time or data source identifiers. The input of this step is the formatted result, the normalized query, and the character-string information, and the output is a response message transmitted over the communication path to the terminal.

Step 13:

The terminal renders the result and interaction context to the user.

The terminal receives the response message, extracts the tabular information, graph specification, query text, and original request text, and uses a user interface framework to draw visual elements on the display apparatus. The terminal renders the chart or table and shows the associated query and user instruction in a combined layout. The input of this step is the response message from the server, and the output is a visual presentation on the display apparatus that the user can view and evaluate.

Step 14:

The user optionally provides an additional input to refine the request.

The user examines the displayed information, including the chart, table, and underlying query, and decides whether a refinement is needed, such as narrowing the time range or adding a filter. The user then issues an additional voice or text input that references the displayed result, for example, “Only show the last 3 months,” and the terminal captures this input. The input of this step is the visual presentation and the user's intention to refine the request, and the output is a new analog speech signal or text string representing the additional input.

Step 15:

The server incorporates the additional input into a new prompt sentence and regenerates a query.

The server receives the additional input through the same pipeline used in earlier steps (speech recognition if necessary, natural language understanding, and schema mapping), but it also uses the context of the previously executed query and its parameters. The server generates a new prompt sentence that explicitly references the prior query and the new constraints, instructing the generative AI model to adjust the existing query rather than produce an unrelated one. The input of this step is the additional input, the prior normalized inquiry statement, and the stored interpretation context, and the output is a refined prompt sentence and a subsequent regenerated inquiry statement that represent an incremental modification of the earlier query.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional data analysis workflows in business environments generally require a user to operate a general-purpose computing device, manually formulate database queries, and iteratively refine such queries through a trial-and-error process. Even when natural language interfaces are provided, existing systems often perform a simple one-shot translation from natural language to a database query, without robust validation, without leveraging historical interaction context, and without providing real-time, in-situ visualization on a wearable display device. As a result, these systems tend to generate incorrect or unsafe queries, impose significant cognitive and operational burdens on the user, and fail to support fluid, conversational interaction with large-scale data resources.

From a computer-technology perspective, there are several concrete technical problems. First, the pipeline from voice input to executable database query is typically fragmented: speech recognition, natural language understanding, query generation, query execution, and visualization are handled as loosely coupled components with little feedback between them. This fragmentation leads to latency, inconsistent states, and increased error rates in end-to-end processing. Second, when a generative AI model is used to synthesize database queries, the model may output syntactically invalid, semantically inconsistent, or even harmful queries, because conventional systems treat the model as an opaque black box and lack systematic mechanisms to validate and refine the generated queries. Third, existing systems do not effectively reuse interaction history (for example, prior prompts, generated queries, and query results) to adapt prompt construction and improve subsequent query generation, thereby underutilizing available machine resources and degrading the efficiency and reliability of the overall computing process.

Furthermore, many existing solutions deliver query results to a traditional display terminal, requiring repeated manual context switching by the user. This hinders the use of real-time analytics in physical environments such as retail stores, where hands-free access and situational awareness are critical. Wearable display devices may be used as passive terminals, but conventional architectures merely mirror static content and do not provide tightly integrated, low-latency, interactive visualization controlled through continuous voice and gaze input. As a result, the computing system as a whole cannot fully leverage the capabilities of wearable hardware, network resources, and generative models to provide an efficient human-computer interface.

Accordingly, there is a need for a computer-implemented system that technically improves the end-to-end processing pipeline from voice input to database query execution and visualization. In particular, there is a need for (i) an integrated architecture that connects speech recognition, natural language processing, prompt construction, generative AI-based query synthesis, and database execution in a feedback-controlled manner; (ii) a server-side query validation and adaptive prompt refinement mechanism that constrains and improves outputs of a generative AI model; and (iii) a coordinated control mechanism between the server and a wearable information display apparatus to provide real-time, interactive visualizations driven by continuous multimodal user input. By addressing these issues, the invention aims to reduce query errors, lower computational waste, improve latency, and enhance the reliability and usability of computer systems that provide natural language access to large data resources.

The specific processing by the specific processing unit 290 of the data processing device 12 in Application Example 1 is realized by the following means.

The present invention provides a server comprising a processor configured to receive, via a communication network, a digital audio signal representing a user's spoken data definition instruction captured by an audio input device of a wearable information display apparatus; to execute a speech recognition program to convert the digital audio signal into character information and to execute a natural language processing program to generate text data representing the data definition instruction; to analyze the text data and construct a prompt sentence for a generative AI model, the prompt sentence including constraints on at least a target data structure, attribute names, aggregation conditions, or an output format; to input the prompt sentence into the generative AI model and obtain a structured query language query as an output; to validate the structured query language query by checking for prohibited expressions, consistency of referenced data structures, and syntactic correctness, and, when the query does not satisfy a validation condition, to modify the prompt sentence to add constraint conditions and to cause the generative AI model to regenerate the structured query language query; to transmit a validated structured query language query to an information storage apparatus and to execute the validated structured query language query using a query processing function of an information management system so as to obtain a query result; to perform, on the query result, server-side data processing including at least one of time-series completion, aggregation, numerical transformation, and formatting into a visualization structure so as to generate visualization data in a structured information format; to transmit the visualization data to the wearable information display apparatus for graphical rendering; and to record, as history information, at least one of the prompt sentence, the generated structured query language query, and attribute information related to the query result, and to update at least one of a configuration rule for constructing the prompt sentence and a query validation condition based on the history information in order to adapt and improve subsequent prompt construction and query generation by the generative AI model. This enables a technically improved, integrated processing pipeline in which voice-based user instructions are reliably transformed into validated database queries and interactive visualizations, reduces erroneous or unsafe outputs from the generative AI model through server-side validation and adaptive prompt refinement, leverages historical interaction data to optimize future query generation, and provides low-latency, hands-free, context-aware access to data resources via coordinated control of the server and the wearable information display apparatus.

The term “system” refers to a combination of hardware components and software components that cooperate via one or more communication networks to execute the functions described in the claims.

The term “processor” refers to one or more hardware processing units, such as a central processing unit or a graphics processing unit, configured to execute instructions of one or more programs to perform the operations described in the claims.

The term “server” refers to a computing apparatus including at least one processor, a memory, and a communication interface, configured to provide processing, storage, or control functions for one or more client devices over a communication network.

The term “wearable information display apparatus” refers to an information processing device configured to be worn on a user's body, such as head-mounted display equipment or smart glasses, and including at least a display unit, an audio input device, a communication interface, and a control unit.

The term “audio input device” refers to hardware for capturing sound, such as at least one microphone and associated circuitry, configured to convert acoustic signals into digital audio signals.

The term “digital audio signal” refers to time-series data representing sampled and quantized audio information, which can be processed, stored, or transmitted by a computing apparatus.

The term “communication network” refers to a wired or wireless data transmission infrastructure, such as a local area network, a wide area network, or a mobile communication network, that enables exchange of data between the server and other devices.

The term “speech recognition program” refers to software executed by a processor to convert a digital audio signal into character information by applying acoustic models, language models, or other algorithms for recognizing spoken language.

The term “natural language processing program” refers to software executed by a processor to analyze character information or text data expressed in a human language, and to perform tasks such as tokenization, parsing, semantic analysis, or intent extraction.

The term “character information” refers to symbolic data, such as strings or sequences of characters, representing recognized words, phrases, or sentences obtained from speech recognition processing.

The term “text data” refers to structured or unstructured data composed of one or more characters, words, or sentences, representing a user's data definition instruction or related content in a natural language.

The term “data definition instruction” refers to a user's request, expressed in natural language, that specifies at least one of a data source, a filter condition, an aggregation condition, or an output format for retrieving or analyzing data.

The term “prompt sentence” refers to text data constructed to be input to a generative AI model, including at least part of a user's data definition instruction and optionally additional constraints, context information, or schema information, for the purpose of generating a database query.

The term “generative AI model” refers to a machine learning model, such as a large language model, configured to generate text output in response to input text, including generation of database queries based on a prompt sentence.

The term “structured query language query” refers to a statement conforming to a structured query language or a similar declarative data manipulation language, configured to request retrieval or processing of data stored in an information storage apparatus.

The term “information storage apparatus” refers to hardware and software that store data in a persistent or semi-persistent manner, such as a database system, a data warehouse system, or a storage subsystem including non-volatile memory.

The term “information management system” refers to software, such as a database management system, configured to manage, store, retrieve, and process structured or semi-structured data, and to execute query statements received from a client.

The term “query processing function” refers to functionality of an information management system that parses, optimizes, and executes query statements, and returns corresponding query results.

The term “prohibited expressions” refers to words, tokens, or syntactic constructs in a query, such as destructive operations or unauthorized access patterns, that are disallowed according to predefined security or safety policies.

The term “referenced data structures” refers to schema elements such as table names, view names, column names, or relationships specified in a query or schema definition.

The term “syntactic correctness” refers to conformance of a query statement to the grammar rules of the target query language, such that the query can be parsed and executed by the information management system.

The term “query result” refers to data returned by an information management system in response to execution of a query, typically represented as one or more records, fields, or structured objects.

The term “time-series completion” refers to a data processing operation that fills in missing time points or intervals in time-indexed data, for example by inserting records with default values or interpolated values.

The term “aggregation” refers to a data processing operation that combines multiple data records into a summarized form, such as by computing a sum, average, count, minimum, maximum, or other statistical measure.

The term “numerical transformation” refers to a data processing operation that modifies numerical values, such as scaling, rounding, normalization, or computation of derived metrics.

The term “visualization structure” refers to an arrangement or data schema prepared for graphical rendering, including axis labels, series data, categories, and metadata used to display charts, graphs, or tables.

The term “visualization data” refers to structured information produced for the purpose of graphical display, derived from query results and formatted according to a visualization structure.

The term “display unit” refers to hardware for presenting visual information to a user, such as a microdisplay, an optical see-through display, or a projection system incorporated into a wearable information display apparatus.

The term “business indicators” refers to quantitative or qualitative measures derived from data, such as sales trends, aggregates by category, or comparative metrics, used to evaluate or monitor business performance.

The term “additional input” refers to user input provided after an initial data definition instruction, including subsequent voice commands, gaze-based operations, or other interaction modalities that refine or modify a query or visualization.

The term “gaze operation instruction” refers to a user command inferred from eye movement or gaze direction detected by a sensor, used to select, confirm, or manipulate visual elements on a display.

The term “interactive query control” refers to control logic that incrementally updates queries and query results in response to continuous or successive user inputs, enabling a conversational or iterative query experience.

The term “history information” refers to stored information about past interactions, including at least one of previously used prompt sentences, generated queries, and attributes of prior query results.

The term “configuration rule” refers to a rule or parameter set used to construct a prompt sentence, including templates, schema descriptions, constraint patterns, or instructions for the generative AI model.

The term “query validation condition” refers to a predefined rule or criterion used to determine whether a generated query is acceptable, such as checks for syntax, schema consistency, security policy compliance, or resource usage limits.

The term “virtual screen” refers to a logical display region rendered by a wearable information display apparatus in a user's field of view, which appears as a screen at a certain position and orientation in space.

The term “time-series display” refers to a display mode in which data values are rendered as a function of time, for example as a line chart or bar chart with time on one axis.

The term “category-wise aggregation display” refers to a display mode in which data aggregated by category or group is rendered, for example as a bar chart, pie chart, or table listing categories and corresponding aggregated values.

The term “comparative display” refers to a display mode in which two or more data sets or time periods are shown together for comparison, for example by overlaying multiple series or presenting side-by-side visualizations.

The term “spatial layout” refers to an arrangement of one or more virtual screens or visual elements at different positions, depths, or orientations within the user's perceived three-dimensional space.

The term “display mode” refers to a manner of presenting data on the display unit, including chart type, visual emphasis, level of detail, or combination of visual elements.

The term “arrangement of the virtual screen” refers to the positioning, ordering, size, or orientation of one or more virtual screens within the spatial layout as perceived by the user.

In one embodiment, the system is implemented as a distributed computer system including at least one server and at least one terminal in the form of a wearable information display apparatus. The server includes a multi-core central processing unit, a main memory, a non-volatile storage device such as a solid-state drive, and a network interface. The terminal includes a head-mounted display, a microphone as an audio input device, one or more sensors for gaze detection, a local processor, a memory, and a wireless communication interface. The server executes a server-side operating system such as a general-purpose server operating system and a runtime environment such as a Python runtime. The terminal executes a client-side operating system such as a mobile operating system with a graphical rendering engine such as an OpenGL ES or game-engine-based renderer.

The server stores in its non-volatile storage a set of software modules that define a processing pipeline from voice input to visualization output. The server includes a speech recognition module, a natural language processing module, a prompt construction module, a generative AI query generation module, a query validation module, a database access module, a data processing and visualization formatting module, and a history management module. The server also stores a pre-trained generative AI model in the form of a neural-network-based language model and a configuration database describing the schema of one or more information storage systems. The terminal stores a display control module, a communication control module, an audio capture module, a gaze detection module, and a visualization rendering module.

The terminal captures a user's spoken data definition instruction through the microphone. The terminal converts, by its audio capture module and local audio driver, the analog acoustic signal into a digital audio signal at a predetermined sampling frequency and bit depth, for example 16 kHz and 16 bits per sample. The terminal compresses or packetizes the audio signal and transmits it to the server via a wireless communication network using a secure transport protocol. The terminal thereby acts as an input/output interface that offloads computationally intensive tasks such as speech recognition, natural language processing, and database query generation to the server.

The server receives the digital audio signal through the network interface and stores the signal in a buffer in main memory. The server executes the speech recognition module to transform the audio signal into character information. In one implementation, the speech recognition module uses an acoustic model and a language model trained on domain-specific utterances. The acoustic model may be a deep neural network such as a time-delay neural network or a recurrent neural network that maps sequences of acoustic feature vectors, such as mel-frequency cepstral coefficients, to phoneme probabilities. The language model may be an n-gram model or a neural language model that scores candidate word sequences. The server applies a decoding algorithm such as a beam search or Viterbi decoding to produce the most likely character sequence representing the user's spoken instruction. As a result, the server converts the audio signal into text data with explicit character information, reducing ambiguity relative to raw waveform data.

The server then executes the natural language processing module on the text data. The natural language processing module performs tokenization, part-of-speech tagging, syntactic parsing, and semantic role labeling using trained models such as bidirectional recurrent neural networks or transformer-based encoders. The server extracts entities such as table names, time periods, product categories, and metrics, and identifies intent types such as “trend analysis,” “aggregation by category,” or “comparison between periods.” The server also maps natural language phrases to canonical schema elements using a schema dictionary stored in the configuration database. Through this processing, the server generates structured internal representations of the data definition instruction, including slots for target tables, filter conditions, grouping keys, and output forms. This structured representation serves as input to the prompt construction module.

The server constructs a prompt sentence for the generative AI model by combining the recognized instruction with schema information and explicit constraints. The prompt construction module applies configuration rules stored in the configuration database and the history management module. For example, when the user is interacting with sales data, the server may construct a prompt sentence in the following form:

“Based on the following user request, generate a valid SQL query for a relational database.

User request: ‘I want to see the monthly sales trend.’

Database schema: Table name: sales_table. Columns: order_date (DATE), amount (NUMERIC).

Output only the SQL query.”

In another example, when the user issues a follow-up instruction, the server may construct a prompt sentence including the prior context:

“Based on the previous query for last month's sales trend, generate an SQL query that shows total sales by product category for the same period.

User follow-up: ‘Also show me the breakdown by product category.’

Database schema: sales_table (sale_date DATE, product_category TEXT, sales_amount NUMERIC).

Output only the SQL query.”

The server thus performs explicit programmatic control over the content and structure of the prompt sentence, rather than simply passing the raw user text to the generative AI model. This non-trivial prompt construction, guided by schema constraints and history information, reduces the search space for the generative AI model and improves the correctness and stability of the generated queries.

The server executes the generative AI query generation module using the prompt sentence as input. In one embodiment, the generative AI model is implemented as a transformer-based neural network trained as a language model on a large corpus of text including code and database queries. The model includes an embedding layer, multiple self-attention layers, feedforward layers, and a final projection layer to a vocabulary. The server feeds the prompt sentence as a sequence of token identifiers into the embedding layer, applies positional encoding, and performs forward propagation through the stack of self-attention blocks. Each block computes attention weights across the input tokens, multiplies by learned projection matrices, and passes the results through non-linear activation functions. The output logits are transformed into token probabilities from which the server samples or decodes the next tokens, thereby generating the SQL query string token by token until an end-of-sequence token is produced. The server sets decoding parameters such as temperature and top-k or nucleus sampling thresholds to balance diversity and determinism. In alternative embodiments, the generative AI model may be a sequence-to-sequence encoder-decoder architecture or a hybrid model with rule-based post-processing.

The server does not directly trust the raw output of the generative AI model. Instead, the server executes the query validation module to analyze the generated SQL query. The query validation module tokenizes the SQL string and parses it using a query parser compatible with the target database system. The server checks for prohibited expressions, such as data definition or data manipulation statements that are not allowed in the context of read-only analytics. The server cross-checks referenced table names and column names against the configuration database to detect schema mismatches. The server also checks constraints such as maximum allowed number of joins or maximum time range, and normalizes ambiguous constructs. If any validation condition fails, the server records the failure in the history management module and modifies the prompt sentence by adding explicit instructions, such as “Do not use DELETE, UPDATE, or INSERT statements. Use only SELECT statements on table sales_table.” The server then re-invokes the generative AI model with the modified prompt sentence to regenerate the SQL query. This iterative, rule-based refinement process is executed automatically by the server and is not a simple human-like trial and error; instead, it is driven by machine-executable validation rules and schema constraints that directly improve computational stability and data safety.

The server connects to an information storage apparatus such as a relational database system or data warehouse via the database access module. The server uses a database connectivity library, for example an abstraction layer that manages connection pooling, prepared statements, and transaction control. The server sends the validated SQL query to the database system, which executes it using its query optimizer and execution engine. The server receives the query result as a set of records, which may include columns such as time stamps, category identifiers, and numeric measures. The server converts the result into internal data structures such as arrays or columnar representations.

The server then executes the data processing and visualization formatting module. In this module, the server performs machine-level operations to transform the raw query result into visualization data. The server applies time-series completion by scanning the time dimension for missing intervals and inserting synthetic records with default values, reducing the need for the terminal to handle irregular data. The server performs aggregation operations such as sum, average, and ratio calculation using optimized numeric libraries, thereby reducing the processing load on the database by offloading some computations to the application layer when appropriate. The server applies numerical transformations such as scaling, rounding, normalization, and computation of derived metrics (for example, percentage change from a previous period or rolling averages). The server finally formats the processed data into a visualization structure, for example specifying x-axis labels, series names, data values, and legends, and serializes this structure into a compact representation suitable for transmission to the terminal. By performing these operations on the server, the system reduces the computational and energy burden on the wearable terminal and ensures consistent visualization semantics across different terminals.

The server transmits the visualization data to the terminal over the network. The terminal receives the visualization data, parses it, and feeds it to the visualization rendering module. The terminal uses its graphical engine to render charts, graphs, and tables as virtual screens in a head-mounted display environment. The terminal places one or more virtual screens at specified three-dimensional positions relative to the user's field of view, and draws axes, lines, bars, labels, and legends according to the visualization structure. Because the visualization data is already pre-structured and pre-aggregated by the server, the terminal can render the visualizations with low latency and low CPU usage, providing a responsive experience even on resource-constrained wearable hardware.

The terminal also captures additional user input such as follow-up voice instructions and gaze operation instructions. The terminal forwards additional voice instructions to the server in the same manner as the initial instruction. For gaze operations, the terminal uses one or more sensors such as infrared cameras or inertial sensors to detect the direction of the user's gaze and to determine which virtual screen or visual element is being focused on. The terminal encodes gaze-based selections as discrete events or control messages, such as “focus on category breakdown chart” or “switch to comparative view,” and transmits them to the server.

By normalizing gaze information into simple, structured control messages, the terminal reduces bandwidth usage and offloads high-level interpretation to the server.

The server receives the additional input and updates the internal context stored in the history management module. The history management module maintains for each user session a record of prior prompt sentences, generated queries, query results, and visualization states. The server combines the new input with the existing context to construct an updated prompt sentence. For example, when a user says “Compare this with the previous year,” while focusing on a monthly sales trend chart, the server constructs a prompt sentence such as: “The user is currently viewing a chart that shows total sales per month for the current year. Generate an SQL query that compares the same months with the previous year.

Output only the SQL query, using table sales_table with columns: order_date (DATE), amount (NUMERIC).”

By explicitly including the current context and schema information, the server reduces ambiguity for the generative AI model and increases the likelihood of producing an accurate comparative query. The server then repeats the generative AI query generation and validation process described above to obtain a new SQL query and an updated query result. This interactive process allows the user to engage in multi-step analytical dialogs, while the server maintains computational control and consistency.

The server records prompt sentences, generated queries, and query result attributes as history information. Over time, the server analyzes this history information to adapt configuration rules for prompt construction and query validation. For instance, if the server detects frequent schema-related validation failures, the server may adjust prompt templates to always include explicit schema definitions. If the server detects repeated patterns of user behavior, such as frequent requests for “last week” when the user says “recently,” the server may map ambiguous temporal terms in pre-processing to standard date ranges. These adaptations are implemented as deterministic rule updates or parameter adjustments in the prompt construction module and query validation module, thereby improving accuracy and reducing processing time in subsequent interactions. This history-based adaptation constitutes an improvement to the internal operation of the computer system, because the system reduces redundant invocations of the generative AI model, reduces failed query attempts, and optimizes the use of computational and network resources.

From a technical perspective, the described architecture yields several concrete effects. The server-side validation and iterative prompt refinement reduce the probability of generating syntactically invalid or semantically incorrect queries, which in turn reduces wasted database execution cycles and network transmissions. The server-side aggregation, time-series completion, and formatting reduce the size and complexity of data sent to the terminal, thus lowering communication load and enabling lower-power wearable devices to provide rich visualizations. The explicit use of schema-aware prompt sentences and interaction history in the generative AI model pipeline improves query generation accuracy and reduces latency compared to naive, one-shot mappings from natural language to SQL. Because these improvements are rooted in specific data structures, algorithms, and control flows implemented by the server and terminal, they represent enhancements to computer functionality rather than mere automation of human thought processes.

In alternative embodiments, the server may use different neural network architectures for the generative AI model, such as encoder-decoder models with attention mechanisms or hybrid models combining neural networks with symbolic rule engines. The server may adjust training parameters such as learning rate, batch size, and regularization coefficients during pre-training or fine-tuning of the generative AI model on domain-specific query corpora. The server may apply different loss functions, such as cross-entropy loss over token sequences or reinforcement-learning-based objectives that reward syntactic validity and execution success. The server may also use data augmentation techniques such as paraphrasing, synonym substitution, and schema-driven query generation to enrich training data. These variations further improve robustness and generalization of the query generation process.

The server may also employ alternative algorithms in the query validation module. For example, the server may implement static analysis of query plans produced by the database optimizer, rejecting queries whose estimated cost exceeds a threshold or whose access patterns violate predefined policies. The server may maintain a whitelist of allowed tables and columns and a blacklist of dangerous functions. The server may also use pattern matching against known safe query templates, selectively combining template-based generation with model-based generation. These mechanisms ensure that the generative AI model's output is constrained by deterministic, machine-enforceable rules, providing safety and predictability. On the terminal side, different visualization modes and spatial layouts may be used. The terminal may display time-series trends in front of the user at a default distance, while placing category-wise aggregation charts to the left or right, and comparative displays above or below. The terminal may change color schemes, level of detail, or chart types in response to user commands. The terminal may also adjust rendering resolution and frame rate based on available bandwidth and processing capacity, as indicated by feedback from the server. These design choices improve usability while respecting hardware limitations.

In another embodiment, multiple terminals may connect to a common server, allowing different users to access shared data resources while maintaining individual histories and contexts. The server may allocate separate processing threads or containers for each user session, and may cache frequently used query results or visualization structures to further reduce latency. In yet another embodiment, the server may distribute its functions across multiple physical machines, with dedicated nodes for speech recognition, generative AI inference, database access, and visualization formatting, communicating via internal networks.

Because the server coordinates these modules as an integrated pipeline, the system achieves a technically improved mode of operation compared to conventional, loosely coupled solutions. Data flows from voice input through structured, validated transformations into optimized visualizations, with explicit, rule-based control over each stage. Thus, the user obtains real-time, interactive access to complex data resources through a wearable display, while the underlying computer system operates more efficiently, reliably, and safely than prior systems that rely on ad hoc scripts or manual query formulation.

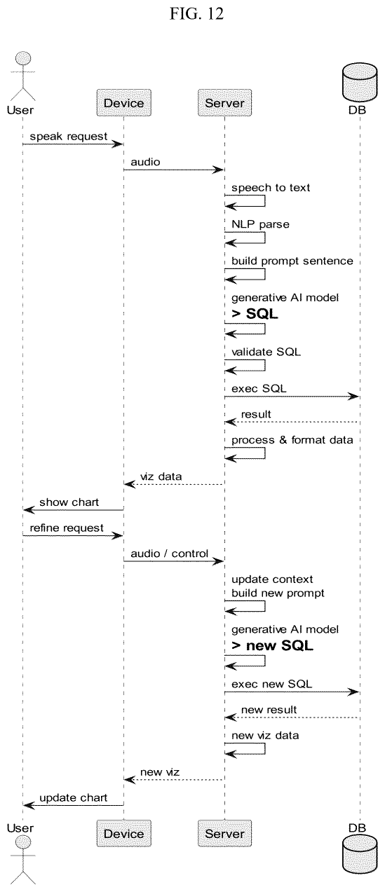

The following describes the processing flow using FIG. 12.

Step 1:

The user speaks a data definition instruction such as “Show me the sales trend for last month” while wearing the terminal.

Input: Natural human speech in analog acoustic form.

Output: Airborne sound waves containing the user's instruction.

The user directs the voice toward the microphone of the terminal without operating any physical buttons, thereby initiating a hands-free interaction.

Step 2:

The terminal captures the user's voice through the built-in microphone and converts the analog sound into a digital audio signal.

Input: Analog acoustic signal from the user's speech.

Output: Digitized audio data, for example 16-bit PCM samples at a fixed sampling rate.

The terminal uses an audio driver of its operating system to sample the analog signal, quantize it, and buffer the resulting audio frames in memory, optionally encoding the data using a compression codec before transmission.

Step 3:

The terminal transmits the digital audio signal to the server via a communication network.

Input: Buffered digital audio data and associated metadata such as user identifier, session identifier, and language code.

Output: A network request, such as an HTTPS message, carrying the audio payload to the server.

The terminal establishes a secure network connection, encapsulates the audio data in a request message, attaches headers for authentication and language specification, and sends the message to a designated server endpoint.

Step 4:

The server receives the network request and stores the digital audio data in a buffer.

Input: Network packets containing the audio payload and metadata.

Output: Reconstructed audio stream stored in main memory as a continuous or chunked buffer.

The server's communication module reassembles packets, verifies integrity using checksums or transport-layer mechanisms, authenticates the request using tokens or certificates, and writes the audio data into a temporary storage area for processing.

Step 5:

The server executes a speech recognition program to convert the digital audio signal into character information.

Input: Buffered digital audio stream representing the user's speech.

Output: Recognized text string, for example “Tell me the sales trend for last month”.

The server extracts acoustic features such as mel-frequency cepstral coefficients from the audio, feeds them into an acoustic model, computes likelihoods for phoneme or character sequences, applies a language model to score candidate text sequences, and performs decoding to select the most probable character sequence.

Step 6:

The server executes a natural language processing program to analyze the recognized text and generate structured text data representing the data definition instruction.

Input: Recognized text string in a natural language.

Output: Structured representation including tokens, identified entities, intent type, and candidate schema elements.

The server performs tokenization, part-of-speech tagging, and syntactic parsing, extracts entities such as “last month” and “sales”, maps these entities to schema elements like a “sales_table” and a “date” column, and determines that the user intends to request a time-series trend aggregation.

Step 7:

The server constructs a prompt sentence for a generative AI model using the structured text data and schema information.

Input: Structured representation of the user's instruction and configuration data describing database tables and columns.

Output: A prompt sentence in text form suitable as input to the generative AI model.

The server inserts the user's request, the table name, column names, and explicit constraints into a template, for example:

“Based on the following user request, generate a valid SQL query for a relational database.

User request: ‘I want to see the monthly sales trend.’

Database schema: Table name: sales_table. Columns: order_date (DATE), amount (NUMERIC).

Output only the SQL query.”

The server thus converts semantic slots and schema descriptors into a linear text prompt.

Step 8:

The server inputs the prompt sentence into the generative AI model and generates a candidate structured query language query.

Input: Prompt sentence describing the user's request and database schema.

Output: Generated SQL query text representing a candidate database query.

The server tokenizes the prompt, maps tokens to embeddings, propagates them through the layers of a neural network-based language model, computes token probability distributions at each position, and decodes a sequence of tokens that form the SQL query, such as a SELECT statement with GROUP BY and ORDER BY clauses.

Step 9:

The server validates the generated SQL query using a query validation module.

Input: Candidate SQL query string produced by the generative AI model.

Output: Either a validated SQL query or a determination that regeneration is required.

The server parses the SQL string, checks its syntax against the grammar of the target database system, compares referenced table and column names with schema definitions, and scans for prohibited operations such as data modification statements. If the query violates a rule, the server marks it as invalid and prepares to adjust the prompt sentence.

Step 10:

The server refines the prompt sentence and regenerates the SQL query when validation fails.

Input: Invalid SQL query, validation error details, and the previous prompt sentence.

Output: Updated prompt sentence with additional constraints and a new generated SQL query.

The server adds explicit instructions such as “Use only SELECT statements and do not include DELETE, UPDATE, INSERT, or DROP.” to the prompt sentence, re-submits the updated prompt to the generative AI model, and obtains a new SQL query, thereby using validation feedback to constrain future outputs.

Step 11:

The server transmits the validated SQL query to an information storage apparatus and requests execution.

Input: Validated SQL query string and database connection information.

Output: Execution request sent to a database system or data warehouse.

The server uses a database access library to open or reuse a connection, sends the SQL string to the database engine, and instructs the engine to execute the query under a controlled context such as a read-only transaction.

Step 12:

The server receives a query result from the information storage apparatus.

Input: Response from the database containing rows and columns matching the SQL query.

Output: In-memory data structures representing the query result, such as lists of records or column arrays.

The server reads the result set from the database connection, converts low-level protocol data into typed values (for example, dates and numeric amounts), and stores them in data objects for further processing.

Step 13:

The server performs data processing on the query result to prepare visualization data.

Input: Raw query result containing fields such as dates, categories, and numeric measures.

Output: Processed data in a visualization structure with axes, series, and labels.

The server scans the time dimension to insert missing time points, aggregates data by specified keys, computes metrics such as totals and percentage changes, normalizes or scales numeric values, and organizes the results into arrays or maps that define chart axes and series names.

Step 14:

The server formats the processed data into a structured visualization representation suitable for transmission.

Input: Visualization-structured data describing chart elements.

Output: Serialized visualization data in a compact representation.

The server encodes axis labels, series definitions, and data points into a structured format, compresses the representation when necessary, and attaches metadata such as titles and legends, thereby producing a payload that the terminal can directly render.

Step 15:

The server transmits the visualization data to the terminal via the communication network.

Input: Serialized visualization data and session identification information.

Output: Network response message sent to the terminal containing the visualization payload.

The server uses a server-side communication framework to construct an HTTP or similar response, sets headers indicating content type and encoding, and sends the response to the terminal over an established secure connection.

Step 16:

The terminal receives the visualization data and reconstructs the visualization structure in memory.

Input: Network packets containing serialized visualization data.

Output: In-memory representation of chart elements ready for rendering.

The terminal's communication module reconstructs the payload from packets, parses the structured representation, and populates local structures such as arrays of x-axis labels and numeric series values.

Step 17:

The terminal renders the visualization on the wearable display as one or more virtual screens.

Input: Visualization structure including axes, series, and display metadata.

Output: Graphical output on the display unit perceived as charts, graphs, or tables.

The terminal calls its graphical rendering engine to draw axes, ticks, lines, bars, and text labels, assigns colors and styles according to the metadata, and positions the virtual screen within a three-dimensional coordinate system aligned with the user's field of view.

Step 18:

The user observes the visualization and optionally provides additional instructions, such as a follow-up voice command or a gaze-based selection.

Input: Visual presentation of the current query result.

Output: New user input in the form of speech or gaze changes.

The user interprets the displayed information and decides on a refinement, for example by saying “Show the breakdown by category” or by focusing gaze on a particular chart to indicate interest in that element.

Step 19:

The terminal captures the additional user input and encodes it as control data for the server.

Input: New analog voice signal and/or sensor signals indicating gaze direction.

Output: Control messages including additional text or selection identifiers transmitted to the server.

The terminal repeats the audio capture and digitization process for voice, converts gaze sensor data into identifiers such as selected chart IDs, packages this information with session context, and sends it to the server as a follow-up request.

Step 20:

The server updates interaction history and reconstructs an updated prompt sentence that incorporates both the new input and past context.

Input: Additional user input, current visualization state, and stored history of prompts and queries.

Output: Context-aware prompt sentence for the generative AI model and an associated updated internal representation.

The server retrieves the last executed query and visualization description from the history, combines them with the new instruction, adjusts schema references and time ranges accordingly, and builds a new prompt sentence such as “Based on the previous query for last month's sales trend, generate an SQL query that shows total sales by product category for the same period,” enabling context-sensitive generation.

Step 21:

The server repeats query generation, validation, execution, and visualization preparation based on the updated prompt sentence, thereby providing an interactive query cycle.

Input: Context-aware prompt sentence and existing session data.

Output: Updated visualization data and a modified display at the terminal.

The server again invokes the generative AI model to produce a new SQL query, validates the query, executes it against the database, processes the result into visualization data, and sends the updated data to the terminal, which re-renders the display so that the user can iteratively explore the dataset in a conversational and technically controlled manner.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional database access systems require users to possess specialized knowledge of query languages and data schemas in order to retrieve and analyze data stored in large-scale data storage infrastructures such as data warehouses. In such systems, users must manually formulate valid structured query language (SQL) statements, understand table structures, and handle syntax and optimization details. This requirement imposes a significant barrier on non-expert users, increases the cognitive load on expert users, and often leads to inefficient query formulations, repeated trial-and-error executions, and suboptimal use of computational and storage resources.

Some systems attempt to provide natural language interfaces to databases by performing keyword search or rule-based mapping from natural language to fixed query templates. However, these approaches frequently fail when handling complex analytical intentions, combinations of conditions, or evolving data schemas. Moreover, conventional natural language interfaces typically do not maintain a rich conversational context, do not leverage large-scale generative models to flexibly translate user intents into executable queries, and do not provide mechanisms to propagate system constraints and schema metadata into the query generation process. As a result, such systems may generate invalid or inefficient queries, require extensive manual correction, and degrade overall system performance and reliability. In addition, existing systems often treat query generation, query execution, and result presentation as separate, loosely coupled processes. They do not systematically use machine-generated results or prior queries as feedback to refine subsequent query generation. This lack of tight integration prevents the system from adaptively guiding the generative model, from constraining the model output according to data storage constraints, and from iteratively improving query accuracy and efficiency over multiple user interactions. Consequently, server-side resources may be wasted on redundant or erroneous queries, and the responsiveness of the system may degrade under heavy load.

Furthermore, many systems do not provide structured mechanisms to encode data storage metadata, aggregation policies, and output format constraints into the prompts supplied to a generative AI model. Without such mechanisms, the generative model may over-generate unnecessary query structures, access unintended data sets, or produce outputs requiring extensive post-processing. This increases processing overhead on the server, complicates validation of generated queries, and may expose the system to security and compliance risks. Accordingly, there is a need for an improved computer-implemented technique that enables a server to: (i) receive natural language information definition instructions from terminals, (ii) construct and manage prompt sentences for a generative AI model including explicit metadata and constraint information, (iii) generate, inspect, and, when necessary, automatically modify database queries prior to execution, (iv) execute such queries efficiently on a data storage device, (v) perform systematic post-processing and formatting of result data for visualization, and (vi) iteratively refine query generation by using prior queries and query results as feedback. By improving these server-side mechanisms, the underlying computer system can reduce invalid or inefficient query executions, lower computational overhead, and provide more accurate and responsive data access for users who interact only in natural language.

The specific processing by the specific processing unit 290 of the data processing device 12 in Example 2 is realized by the following means.

The present invention provides a server comprising a processor configured to receive, via a communication network, character information representing an information definition instruction expressed in natural language by a user and transmitted from a terminal; to generate a prompt sentence including the information definition instruction and control information describing at least one of a table structure, an item attribute, and an aggregation policy of a data storage device as metadata, and to structure the prompt sentence as input data for a generative AI model; to supply the prompt sentence to the generative AI model and cause the generative AI model to analyze the prompt sentence so as to interpret an intention and a condition contained in the information definition instruction and to generate a database query in a structured query language corresponding to the information definition instruction; to inspect the generated database query to determine whether the database query conforms to an allowed logical structure and to a data structure stored in the data storage device, and, when necessary, to modify the database query by adding a restriction condition; to transmit the inspected database query to the data storage device and cause a query processing function of the data storage device to execute the database query and return query result data comprising at least one of an aggregation result and an extraction result; to perform post-processing on the query result data including at least one of aggregation processing, ratio calculation processing, sorting processing, and conversion processing into a data structure for visualization, and to format the query result data into display data; to transmit the display data to the terminal so that the terminal presents the display data to the user via an output device; and to receive, via the terminal, an additional information definition instruction from the user, to update the prompt sentence for the generative AI model based on at least one of the query result data and a previous database query, and to repeatedly execute interactive query processing in natural language. This enables the computer system to technically improve server-side query generation and execution by constraining and guiding a generative AI model with explicit metadata and feedback from actual query outcomes, thereby reducing invalid or inefficient queries, optimizing utilization of data storage and processing resources, and providing responsive, natural-language-based access to structured data without requiring users to possess specialized knowledge of query languages or data schemas.

The term “system” refers to an arrangement of at least one computing device, at least one storage device, at least one communication interface, and associated software components that cooperate to perform the functions described herein.

The term “processor” refers to one or more hardware processing units, such as a central processing unit or a graphics processing unit, and any associated control circuitry, that execute instructions to implement the functions described herein.

The term “terminal” refers to an information processing apparatus, such as a client device including at least one input device, at least one output device, and a communication interface, that transmits user instructions to a server and receives display data from the server.

The term “user” refers to a human operator who provides instructions and views results through the terminal and does not necessarily possess specialized knowledge of database query languages or data schemas.

The term “information definition instruction” refers to a specification, expressed in natural language by the user, of desired data content, conditions, and analytical operations to be performed on data stored in a data storage device.

The term “natural language” refers to a human language, such as a spoken or written language used for everyday communication, that is not restricted to a formal programming or query language syntax.

The term “character information” refers to data representing a sequence of characters or symbols, including letters, numerals, and punctuation, encoded in a machine-readable format and corresponding to a user's natural language instruction.

The term “communication network” refers to a wired or wireless data transmission infrastructure that enables digital communication between the terminal, the server, and the data storage device.

The term “prompt sentence” refers to a data structure containing at least a natural language instruction from the user and optionally metadata or control information, formatted as input to a generative AI model to guide generation of a database query or other output.

The term “control information” refers to additional data that describes constraints, schema information, aggregation policies, or output format requirements and that is included in the prompt sentence to influence the behavior of the generative AI model.

The term “generative AI model” refers to a machine-implemented inference model, such as a neural network-based large language model, that receives a prompt as input and generates text data, including database queries and explanatory sentences, as output.

The term “input data for a generative AI model” refers to structured information, including at least one prompt sentence, that is supplied to the generative AI model to cause the generative AI model to generate a response.

The term “database query” refers to a machine-readable statement that specifies retrieval, aggregation, or manipulation of data stored in a data storage device.

The term “structured query language” refers to a standardized or dialectal query language designed to manage and retrieve structured data in a relational or relational-like data storage system.

The term “data storage device” refers to a logical or physical storage subsystem, such as a database or data warehouse, that stores structured data and provides a query processing function to execute database queries.

The term “table structure” refers to a schema definition of a table stored in the data storage device, including at least a table name, one or more column names, and corresponding data types.

The term “item attribute” refers to a property or characteristic of a data element, such as a column name, data type, unit, constraint, or semantic role associated with a field in the data storage device.

The term “aggregation policy” refers to a rule or guideline specifying how data is to be aggregated, such as by sum, count, average, grouping key, or time period, when generating query results.

The term “metadata” refers to descriptive data about data, including at least schema information, table structures, item attributes, and aggregation policies associated with the data stored in the data storage device.

The term “allowed logical structure” refers to a set of predefined constraints governing a database query, including permitted operations, permitted tables and columns, and syntactic patterns, that the query must satisfy before execution.

The term “restriction condition” refers to an additional constraint, such as a filter clause, limit clause, or scope limitation, that is added to a database query to control the amount, type, or range of data returned.

The term “query processing function” refers to a computational function provided by the data storage device that parses, optimizes, and executes database queries and returns corresponding result data.

The term “query result data” refers to data output by the data storage device in response to execution of a database query, including at least one of aggregated values, filtered records, and grouped statistics.

The term “aggregation result” refers to query result data that has been combined according to one or more aggregation operations, such as sum, count, average, minimum, or maximum over a group of records.

The term “extraction result” refers to query result data that has been obtained by selecting records or fields that satisfy one or more conditions specified in a database query, without necessarily applying an aggregation operation.

The term “post-processing” refers to one or more operations performed on query result data after execution of a database query, including at least aggregation processing, ratio calculation processing, sorting processing, and conversion into a visualization-oriented structure.

The term “aggregation processing” refers to a computational operation, performed after initial query execution, that combines multiple data items into a single representative value or a smaller set of values.

The term “ratio calculation processing” refers to a computational operation that derives relative values, such as percentages or proportions, from query result data by comparing one or more quantities to a reference quantity.

The term “sorting processing” refers to an operation that orders query result data according to one or more keys, such as numerical values, text values, or timestamps.

The term “data structure for visualization” refers to an arrangement of data, such as arrays, key-value pairs, or hierarchical objects, formatted to be directly consumed by a rendering component to produce tables, charts, or other visual outputs.

The term “display data” refers to data that has been formatted into a structure and representation suitable for presentation on an output device of the terminal, including tabular data and graphical configuration data.

The term “output device” refers to a hardware component of the terminal, such as a display screen, speaker, or printer, that presents information to the user.

The term “tabular format” refers to a representation of data organized into rows and columns, such as a table of records and fields, suitable for display on an output device.

The term “graphical format” refers to a representation of data as visual elements, such as charts, graphs, diagrams, or icons, for display on an output device.

The term “additional information definition instruction” refers to a further natural language instruction supplied by the user after viewing prior query results, specifying a refinement, modification, or extension of a previous data retrieval or analysis request.

The term “previous database query” refers to a database query that has been generated and executed earlier in a current interaction session and whose structure or contents are available to guide subsequent processing.

The term “interactive query processing in natural language” refers to a sequence of operations in which the system repeatedly receives natural language instructions from the user, generates and executes corresponding database queries, and returns results, while using prior queries and results as context to refine subsequent processing.

The term “summary description” refers to a condensed textual explanation generated from query result data, highlighting key findings or trends in a human-readable form.

The term “interpretive information” refers to additional textual information that provides context, analysis, or insight regarding query result data, such as comparative statements, inferred patterns, or explanatory notes.

In one embodiment, a server cooperates with at least one terminal and at least one data storage device to implement the claimed system. The server includes a processor, a main memory, a non-volatile storage unit, and a network interface. The processor may be a multi-core central processing unit or a graphics processing unit capable of parallel matrix operations. The main memory may be a volatile semiconductor memory. The non-volatile storage unit may be a magnetic or solid-state storage device. The network interface may be a wired or wireless communication adapter that communicates with the terminal and the data storage device via a packet-switched communication network.

The terminal includes at least one input device, at least one output device, a network interface, and a local processor. The terminal may be realized as a general-purpose personal computer, a tablet device, or a smartphone. The input device may include a keyboard, a touch panel, or a pointing device. The output device may include a liquid crystal display or an organic electroluminescent display. The terminal executes client-side software, such as a web browser or a native application, to present a user interface and to transmit character information representing a user's natural language instruction to the server.

The user operates the terminal to input an information definition instruction in natural language. The user enters the instruction as text via the input device. The terminal encodes the entered characters in a machine-readable format and transmits the encoded instruction to the server via the communication network. The user does not need to know a structured query language or a schema of the data storage device.

The server executes server-side software including a web application component, a query management component, a generative AI interface component, a validation and constraint component, a post-processing component, and a visualization interface component. The server uses an operating system to manage these software components and to control access to the hardware resources.

The server receives, at the web application component, the character information representing the information definition instruction from the terminal. The server stores the received instruction in memory together with session identifiers and timestamps. The server then passes the instruction to the generative AI interface component. The server constructs a prompt sentence that includes the user's natural language instruction and control information describing a structure of at least one table in the data storage device, attributes of items in the table, and aggregation policies.

The server uses, for example, the following prompt sentence as an instruction to a generative AI model:

“You are a query generation engine for a data warehouse. The main table is purchase_table with the columns: customer_id (string), age_group (string), product (string), purchase_date (date), amount (numeric). Generate an SQL query that satisfies the following user request. Use only purchase_table. Do not use DROP, UPDATE, or DELETE. Return only a valid SQL query without explanation. User request: I want to know the purchasing tendencies of customers by age group.”

The server may use an alternative prompt sentence for a more specific instruction:

“Generate an SQL query that analyzes which products are frequently purchased by customers in their 20s and 30s. Use table purchase_table(age_group, product, amount). Group by age_group and product, and compute the number of purchases per group. Output only the SQL query.”

The server structures such a prompt sentence as text data and supplies it as an input to a generative AI model stored in a model execution environment. The generative AI model is implemented as a neural network including an embedding layer, a plurality of transformer layers, and an output projection layer. Each transformer layer may include multi-head self-attention sublayers and position-wise feedforward sublayers. The self-attention sublayers compute attention scores between tokens of the prompt sentence, and the feedforward sublayers apply nonlinear transformations to the attended representations.

The server executes the generative AI model on the processor or on a dedicated accelerator. The generative AI model receives tokenized representations of the prompt sentence, applies an embedding transformation using stored weight parameters, and propagates the embedded tokens through the transformer layers. The generative AI model computes, at each output position, a probability distribution over vocabulary tokens and generates a sequence of tokens representing a database query in a structured query language. The server converts the generated tokens into a character string representing the database query.

The server uses a model that has been pre-trained on large volumes of text and further fine-tuned on pairs of natural language instructions and corresponding database queries. During fine-tuning, the server or an external training system minimizes a loss function such as cross-entropy between the generated tokens and reference tokens. The training system updates weight parameters of the neural network using a gradient-based optimization algorithm such as stochastic gradient descent or a variant thereof. The training system may apply regularization techniques, including dropout and weight decay, and data augmentation techniques, such as paraphrasing of natural language instructions, to improve generalization and robustness in query generation.

The server does not rely solely on the generative AI model's output. The server passes the generated database query to the validation and constraint component. This component includes a parser that analyzes a syntactic structure of the database query and generates an abstract syntax representation. The server compares the abstract syntax representation to a set of allowed logical structures and to stored metadata describing the data storage device. The server checks, for example, whether the query references only permitted tables and columns, whether aggregation functions and groupings are consistent with the aggregation policy, and whether the query omits disallowed operations.

The server modifies the database query by applying non-conventional rule sets stored in the validation and constraint component. The server may add a restriction condition such as a limit on the number of output rows or a constraint on a time period. The server may rewrite a grouping condition or an order condition to reduce processing cost based on historical execution profiles. These rule sets are not mere business rules but are defined to reduce resource consumption in the data storage device and to prevent query patterns that historically cause long execution times or memory overuse. By enforcing such constraints before execution, the server improves utilization efficiency of computing resources in the data storage device.

The server transmits the validated and, if necessary, modified database query to the data storage device through a database connectivity component. The data storage device may be implemented as a relational data warehouse running on a separate server or cluster. The data storage device includes a query processing engine that parses the database query, generates an execution plan, and executes the plan by accessing stored data pages from storage media. The data storage device uses indexing, partitioning, or columnar storage to accelerate scans and aggregations. The data storage device returns query result data to the server over a dedicated database protocol.

The server receives the query result data and stores it temporarily in memory. The post-processing component then performs operations such as aggregation processing, ratio calculation processing, and sorting processing. The server may use, for example, an in-memory data structure representing rows and columns. The server calculates additional metrics, such as percentages of total purchases per age group, and sorts records by purchase counts. The server converts the processed data into a data structure for visualization, such as arrays of category labels and corresponding numerical values.

The server prepares display data for the terminal. The server can generate, for example, table descriptions and chart configuration parameters. The server transmits the display data to the terminal via the communication network. The terminal receives the display data and renders it by drawing table rows and graphical elements on the output device. The terminal may display, for example, a bar chart in which an axis represents product names and another axis represents purchase counts, with different colors showing age groups.

The server further uses the query result data and the previous database query as context for subsequent interactions. The server updates the prompt sentence by including summarized forms of prior queries and key values from the query result data. For example, the server may construct a prompt sentence such as:

“Context: The previous query grouped purchase_table by age_group and product and counted purchases. The top products for customers in their 20s were Product A and Product B. User request: Now generate an SQL query that focuses only on these top products for customers in their 30s.”

By embedding such contextual information directly into the prompt sentence, the server enables the generative AI model to generate subsequent database queries that are consistent with prior results and that avoid recomputing redundant operations. This leads to fewer unnecessary full-table scans and reduces overall processing time in the data storage device. The server can also input the query result data itself to the generative AI model as an additional prompt, for example:

“Given the following aggregated results by age_group and product, generate a concise textual summary explaining which age groups prefer which products.”

The server then obtains a summary description or interpretive information from the generative AI model and transmits this explanation to the terminal together with the numerical results. This functionality does not merely automate human summarization but exploits the generative AI model's learned representation space to identify salient patterns across multiple dimensions of the result data, thereby improving the usability of complex analytical outputs.

The server, by integrating these components and data flows, achieves technical effects beyond simple automation of manual query writing. The server reduces invalid query executions by enforcing structural constraints before contacting the data storage device, reduces network traffic by avoiding repeated transmission of large result sets through guided context-aware prompt construction, and reduces processing time and memory usage in the data storage device by applying rule-based modifications to queries to align them with physical storage layouts and partitioning schemes. The server also improves accuracy of query generation, because the prompt sentences systematically encode metadata and constraints that a human user would not be able to consistently supply.

The generative AI model operates according to a defined architecture and algorithm, rather than through unspecified “judgment.” The server controls input tokenization, attention patterns, and decoding strategies, such as beam search or constrained decoding, to restrict output tokens to syntactically valid and schema-consistent database keywords, table names, and column names. The server may maintain a vocabulary mapping that replaces natural language column descriptions with canonical schema identifiers, and this mapping is applied as a transformation layer between the model's output tokens and the final database query. This non-conventional processing pipeline allows the system to tailor a general-purpose neural network to a specific database environment, thereby improving precision and reducing parsing errors.

The server differs from conventional rule-based systems in that the server does not rely solely on static templates. Instead, the server combines a large-scale generative model with explicit structural constraints and post-generation transformations. The server uses feedback from actual query execution results—such as resource consumption metrics and error codes—to update internal rule sets or to augment future prompt sentences with warnings and restrictions. Over time, this feedback loop allows the system to prioritize query patterns that are both semantically adequate and computationally efficient, thereby improving performance characteristics that are inherent to the computing system itself.

In another embodiment, the server hosts the generative AI model locally on a dedicated accelerator device. In this configuration, the server reduces external network latency for model inference and controls memory allocation within the local environment more tightly. The server can cache embeddings of frequently used prompt segments, such as schema descriptions and aggregation policy texts, and reuse these cached representations in subsequent inferences. By reusing such internal feature vectors, the server reduces redundant matrix multiplications in the neural network and thus lowers inference time and power consumption.

In a further embodiment, the server supports multiple data storage devices with different schema configurations. The server selects, based on metadata, an appropriate prompt sentence template and an appropriate rule set for each data storage device. The server can ask the generative AI model to output queries tailored to a particular dialect of structured query language. This configuration enables a single generative AI model to serve heterogeneous database back-ends while still enforcing device-specific constraints and optimizing for device-specific performance characteristics.

In yet another embodiment, the server records, in a log store, pairs of prompt sentences and validated database queries, together with execution performance data such as execution time and input/output volume. The server may use this logged data to perform additional fine-tuning of the generative AI model or to update the rule sets used by the validation and constraint component. This ongoing adaptation leads to an incremental improvement in query generation quality and system-level resource utilization.

The terminal, in each embodiment, remains relatively simple and does not need to implement complex query logic. The terminal's primary functions are to accept natural language instructions from the user and to render formatted display data received from the server. This separation of responsibilities allows the server to centralize complex processing and to enforce consistent constraints across multiple terminals.

Through these embodiments, the system enables users to access and analyze structured data stored in large-scale data storage devices using only natural language instructions while simultaneously improving internal computer operations, including query generation accuracy, storage access efficiency, processing throughput, and communication overhead.

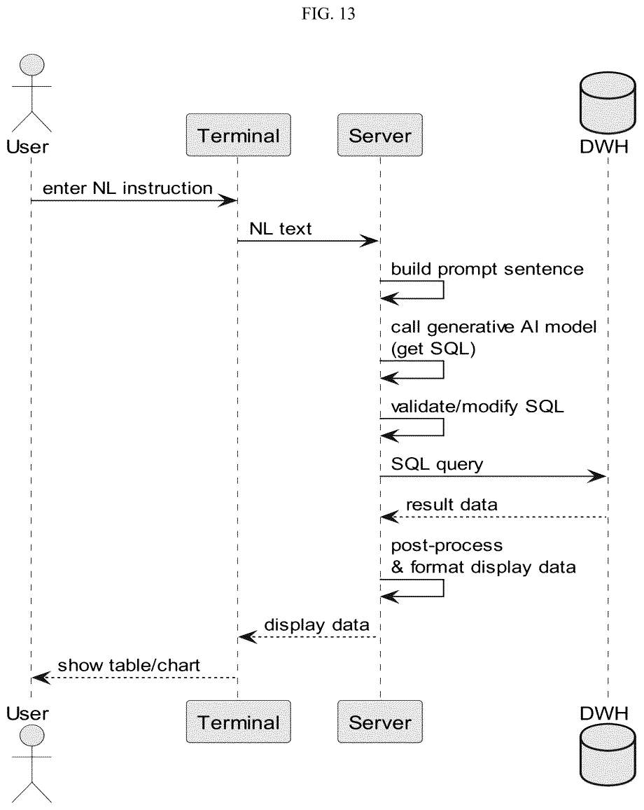

The following describes the processing flow using FIG. 13.

Step 1:

The user inputs an information definition instruction in natural language into the terminal. The user operates a keyboard or touch panel of the terminal and types a sentence such as “I want to know the purchasing tendencies of customers by age group.” as input text.

The terminal receives the keystrokes, constructs a character string encoded in a character code (input: user keystrokes; output: a natural-language text string), and stores the string in a local buffer.

The terminal then embeds the text string, together with a session identifier and user identifier, into a request structure and prepares the data for transmission over a communication network (input: text string; output: structured request data containing the text string and metadata).

Step 2:

The terminal transmits the structured request data to the server via the communication network.

The terminal invokes its network stack, opens a connection to a server endpoint, and sends the request using a communication protocol (input: structured request data; output: network packets carrying the request).

The terminal sets appropriate headers and encodes the body so that the server can correctly parse the character information.

The terminal then waits for a response from the server while maintaining the session context.

Step 3:

The server receives the request from the terminal and extracts the information definition instruction.

The server, via its network interface and web application component, accepts incoming packets, reconstructs the request message, and decodes the body (input: network packets; output: reconstructed request object).

The server parses the request object to obtain the text string representing the user's natural language instruction and associated metadata such as session identifiers (input: request object; output: natural-language text and metadata).

The server stores the text and metadata in main memory and records a log entry for traceability.

Step 4:

The server generates a prompt sentence for a generative AI model based on the received instruction and stored metadata.

The server retrieves schema information, item attributes, and aggregation policies of the data storage device from a metadata store (input: natural-language text and schema metadata; output: combined textual content).

The server concatenates a fixed instruction part with dynamic metadata and the user's text to form a prompt sentence, for example:

“You are a query generation engine for a data warehouse. The main table is purchase_table with the columns: customer_id, age_group, product, purchase_date, amount. Generate an SQL query that satisfies the following user request. Use only purchase_table. Do not use DROP, UPDATE, or DELETE. Return only a valid SQL query without explanation. User request: I want to know the purchasing tendencies of customers by age group.”

The server outputs the prompt sentence as a single text sequence structured for input to the generative AI model (input: instruction and metadata; output: prompt sentence).

Step 5:

The server supplies the prompt sentence to the generative AI model and causes the model to generate a database query in a structured query language.

The server tokenizes the prompt sentence using a tokenizer corresponding to the model (input: prompt sentence; output: sequence of token identifiers), and stores the token sequence in a model input buffer.

The server invokes the model execution environment on a processor or accelerator, feeding the token sequence into the embedding layer, transformer layers, and output projection layer of the model.

The generative AI model computes, using stored weight parameters and attention mechanisms, a probability distribution over output tokens at each position and selects tokens corresponding to SQL keywords, table names, and column names (input: token identifiers; output: token identifiers representing an SQL query).

The server converts the output token identifiers back into a character string and obtains, for example, “SELECT age_group, product, COUNT(*) AS purchase_count FROM purchase_table GROUP BY age_group, product ORDER BY age_group, purchase_count DESC;” as the generated database query (input: output token identifiers; output: SQL query string).

Step 6:

The server validates and, if necessary, modifies the generated database query according to predefined constraints.

The server passes the SQL query string to a parsing component that constructs an abstract syntax representation (input: SQL query string; output: parsed query tree).

The server compares the parsed query tree with allowed logical patterns and checks that referenced tables and columns exist in the stored schema metadata and that no disallowed operations appear (input: parsed query tree and schema metadata; output: validation result and possibly a modified query tree).

The server applies rule-based transformations, such as adding a “LIMIT” clause or constraining a time range, when a validation rule indicates a risk of excessive resource usage (input: original query tree; output: optimized or restricted query tree).

The server then serializes the final query tree back into a validated SQL query string (input: final query tree; output: validated SQL query string).

Step 7:

The server transmits the validated SQL query to the data storage device and requests execution.

The server uses a database connectivity component to open or reuse a session with the data storage device (input: validated SQL query string; output: database command message).

The server sends the command to the query processing engine of the data storage device over a database protocol and waits for a result set or error code.

The server's output at this step is a pending request state associated with the validated SQL query.

Step 8:

The data storage device executes the validated SQL query and returns query result data to the server.

The data storage device parses the SQL query, generates an execution plan, and performs operations such as table scans, filtering, grouping, and aggregation using its internal storage structures (input: validated SQL query; output: in-memory result set).

The data storage device reads records from persistent storage, partitions them by age group and product, and computes counts or other aggregation values as specified by the query.

The data storage device then serializes the result set into a response format and transmits it to the server (input: in-memory result set; output: transmitted result data).

Step 9:

The server receives the query result data from the data storage device and performs post-processing.

The server reads the result data into an in-memory tabular structure, such as rows containing age_group, product, and purchase_count (input: transmitted result data; output: internal tabular data).

The server applies additional aggregation processing, ratio calculation processing, and sorting processing. For example, the server computes purchase_share=purchase_count/total_purchases_per_age_group and sorts products by purchase_count within each age group (input: internal tabular data; output: enriched and ordered tabular data).

The server converts the enriched data into a data structure for visualization, such as lists of categories and corresponding numeric series (input: enriched tabular data; output: visualization-oriented data).

Step 10:

The server formats the visualization-oriented data into display data suitable for the terminal.

The server constructs, for example, a table layout definition and a chart configuration including axes labels, series names, and data points (input: visualization-oriented data; output: display data specification).

The server may also generate a textual explanation by providing the query result data as an additional prompt sentence to the generative AI model, such as:

“Given aggregated counts by age_group and product, generate a short human-readable explanation of which age groups prefer which products.”

The server receives the generated explanation text (input: prompt and result data; output: summary text) and combines it with the display data specification.

The server outputs a composite display data package ready to be transmitted to the terminal.

Step 11:

The server transmits the display data package to the terminal for presentation to the user.

The server sends the package via the communication network and records the transmission in a log (input: display data package; output: network packets carrying display data).

The terminal receives the network packets, reconstructs the display data package, and passes it to the rendering logic (input: network packets; output: display data package at the terminal side).

The terminal interprets the table layout, chart configuration, and summary text, and draws corresponding graphical and textual elements on the output device (input: display data package; output: rendered visual representation on the screen).

Step 12:

The user views the displayed results and optionally issues an additional information definition instruction to refine the analysis.

The user observes, for example, that customers in their 20s frequently purchase certain products and decides to request a refined query: “Show only products frequently purchased by customers in their 20s and 30s.”

The terminal accepts the new text input from the user (input: user keystrokes; output: new natural-language instruction) and again transmits the instruction to the server.

The server then uses the new instruction together with previous query context and result data as input to construct an updated prompt sentence, and the sequence of steps from prompt generation through query execution and result presentation is repeated with the refined parameters.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional information processing systems that convert natural language instructions into database queries, several technical problems arise that limit the efficiency, reliability, and responsiveness of the computing infrastructure itself.

First, a typical system directly maps a user's natural language instruction to a database query by using a fixed rule set or a generic natural language model, without explicitly structuring the interaction between natural language understanding and query generation. As a result, when the instruction is ambiguous, incomplete, or expressed in conversational terms, the system often generates suboptimal or erroneous queries. This leads to unnecessary query failures, repeated retries, and excessive processing cycles on both the application server and the data management system, thereby degrading overall system throughput.

Second, many existing systems do not make explicit use of an intermediate prompt sentence tailored for a generative artificial intelligence model. Without such an intermediate representation that encodes database schema information, attribute constraints, and query intent, a generative model tends to produce queries that are syntactically plausible but semantically incompatible with the actual data management system. This mismatch forces the server to perform costly post-hoc error handling and manual corrections, which increases latency, server load, and network traffic between the application layer and the data layer.

Third, conventional architectures generally ignore emotion or nuance in the user's input. The system treats all requests as equivalent in priority and required level of detail, regardless of whether the user expresses urgency or a desire for deep analysis. Consequently, the server often generates computationally heavy queries for time-critical requests, or overly coarse queries for analysis-oriented requests. This mismatch leads to inefficient utilization of computing resources, such as processor time on the query engine, memory consumption for large intermediate results, and bandwidth usage for unnecessary data transfer, and also results in avoidable delay for urgent tasks.

Fourth, even when a generative model is used to produce structured query language (SQL) statements, existing solutions typically treat the model output as final. There is little or no systematic validation of the generated query against actual schema information, nor dynamic adjustment of aggregation granularity or extraction range based on system constraints and user context. As a result, incorrect column names, nonexistent tables, or overly complex groupings often reach the data management system, causing query errors, wasted execution plans, and repeated query compilation. This behavior directly impacts the efficiency and robustness of the database engine and the surrounding middleware.

Fifth, visualization and result presentation are often performed in a static manner, independent of the semantic content of the query and the inferred user state. A server may always construct the same type of chart or table, regardless of whether the request is urgent or detailed. This static behavior can cause excessive computation and rendering for situations where a minimal summary would be sufficient, and conversely, can underutilize computing resources when a richer, more detailed analysis is appropriate. Such inefficiencies hinder the ability of the overall system to adaptively allocate computational effort in accordance with the user's intent and the real-time workload.

Accordingly, there is a need for a technical mechanism by which a server can: (i) robustly convert natural language instructions, including spoken input, into machine-readable data; (ii) analyze such data to extract structured intent and user emotion; (iii) construct an explicit, schema-aware prompt sentence for a generative artificial intelligence model; (iv) validate and dynamically adjust a generated structured query language query based on both database schema information and inferred emotion; and (v) control visualization and display detail level of query results in a manner that improves processing efficiency and responsiveness of the underlying computing system. The invention is directed to improving the operation of the computer system itself, including the application server, query generation pipeline, and data management system, by reducing failed queries, avoiding unnecessary computation, and adaptively tailoring query complexity and visualization according to the detected user emotion and intent.

The specific processing by the specific processing unit 290 of the data processing device 12 in Application Example 2 is realized by the following means.

The present invention provides a server comprising a processor configured to receive a data definition instruction in natural language from a user via an input apparatus, convert voice information or character information of the user into machine-readable data, analyze the machine-readable data by performing speech recognition processing and natural language processing to extract at least one of a target index, an aggregation unit, and an extraction condition included in the data definition instruction, estimate emotion information of the user by performing emotion analysis processing on the machine-readable data, construct a prompt sentence for generating a database query on the basis of an analysis result and the emotion information, input the prompt sentence to a generative artificial intelligence model to generate a structured query language query, verify the generated structured query language query by referring to schema information stored in a storage apparatus to check syntax and referenced objects, adjust at least one of an aggregation granularity, an extraction range, and a processing load of the structured query language query in accordance with the emotion information to obtain an adjusted structured query language query, transmit the adjusted structured query language query to a data management system and cause the data management system to execute query processing so as to acquire execution result data, apply aggregation processing, sorting processing, and visualization processing to the execution result data while controlling at least one of a display format and a display detail level on the basis of the emotion information to format the execution result data as graphical information or tabular information, and transmit the formatted graphical information or tabular information to a terminal apparatus for presentation to the user via a display apparatus or a sound output apparatus. This enables the computing system to dynamically tailor query generation and result presentation to both the structural characteristics of an underlying data management system and the inferred user emotion, thereby reducing query errors, avoiding unnecessary computation, improving utilization of processing and storage resources, and lowering end-to-end latency in responding to natural language data definition instructions.

The term “data definition instruction” refers to a user instruction expressed in natural language that specifies at least one of a data item, a condition, an aggregation, or a presentation requirement for data retrieval or analysis from a data management system.

The term “input apparatus” refers to a hardware or software interface that acquires voice information or character information from a user and outputs corresponding machine-readable data to a processor.

The term “machine-readable data” refers to data encoded in a format that can be processed by a computing device, including but not limited to digital audio data, character strings, tokens, and structured representations derived from such data.

The term “speech recognition processing” refers to processing that converts digital audio data representing human speech into character-based text data by applying an acoustic model and a language model.

The term “natural language processing” refers to processing that analyzes text data representing human language to extract linguistic or semantic information, including at least one of tokenization, part-of-speech tagging, syntactic analysis, entity extraction, or intent detection.

The term “target index” refers to a measure, metric, or quantity in a data management system that is designated for retrieval, aggregation, or analysis in response to a data definition instruction.

The term “aggregation unit” refers to a logical unit or dimension, such as a time period, a category, or a group, along which data is aggregated or grouped in a database query.

The term “extraction condition” refers to a logical constraint, such as a filter or selection criterion, applied to data in a data management system to limit the data to be retrieved in response to a data definition instruction.

The term “emotion information” refers to information indicating at least one of urgency, level of detail, sentiment, or other affective state inferred from a user's voice information or character information.

The term “emotion analysis processing” refers to processing that analyzes machine-readable data to estimate emotion information associated with a user's input, using at least one of keyword analysis, prosodic analysis, statistical modeling, or machine learning.

The term “prompt sentence” refers to a text sequence that encodes a data definition instruction, schema information, and control directives and that is supplied as input to a generative artificial intelligence model to induce generation of a database query.

The term “generative artificial intelligence model” refers to a trained computational model that generates text data, including a structured query language query, in response to an input prompt sentence, based on probabilistic or neural network-based language modeling.

The term “structured query language query” refers to a sequence of instructions expressed in a structured query language or an equivalent database query language for retrieving, aggregating, or manipulating data stored in a data management system.

The term “schema information” refers to metadata describing at least one of table structures, attribute names, data types, relationships, and constraints of data stored in a data management system.

The term “storage apparatus” refers to a hardware or software component that stores schema information, execution result data, or other data accessible by a processor, including but not limited to a memory device, a storage device, or a database.

The term “aggregation granularity” refers to a level of detail at which data is aggregated in a database query, such as by day, by month, by category, or by region.

The term “processing load” refers to an amount of computational resources required to execute a database query or to perform subsequent processing, including but not limited to processor time, memory consumption, and input/output operations.

The term “extraction range” refers to a scope or extent of data in a data management system targeted by a database query, including at least one of a time span, a set of entities, or a subset of records.

The term “data management system” refers to a system that stores, manages, and processes structured data, including at least one of a database system, a data warehouse, or a distributed data store.

The term “query processing” refers to processing performed by a data management system to interpret and execute a database query, including parsing, optimization, and execution of relational operations.

The term “execution result data” refers to data produced by a data management system as a result of executing a structured query language query, typically represented as one or more records or tuples.

The term “aggregation processing” refers to processing that computes summary values, such as sums, counts, averages, or other aggregate functions, from execution result data.

The term “sorting processing” refers to processing that rearranges execution result data in a particular order based on at least one attribute or computed value.

The term “visualization processing” refers to processing that transforms execution result data into graphical information or tabular information suitable for presentation to a user.

The term “display format” refers to a type or style of presentation of execution result data, including at least one of a chart, a graph, a table, or a textual summary.

The term “display detail level” refers to a degree of granularity or richness of information contained in a presentation of execution result data, such as the number of attributes shown or the depth of breakdowns provided.

The term “graphical information” refers to visual data representations such as line charts, bar charts, pie charts, or other graphical elements generated from execution result data.

The term “tabular information” refers to data arranged in rows and columns, such as a table showing attribute values and aggregated metrics derived from execution result data.

The term “terminal apparatus” refers to a computing device that communicates with the server, receives formatted information, and presents the information to a user, including at least one of a mobile device, a personal computer, or a head-mounted display device.

The term “display apparatus” refers to a component of a terminal apparatus that outputs visual information to a user, including at least one of a liquid crystal display, an organic light-emitting diode display, or a projection display.

The term “sound output apparatus” refers to a component of a terminal apparatus that outputs audio information to a user, including at least one of a speaker, an earphone, or a headset.

In one embodiment, a server cooperates with a terminal and a user to implement the claimed system. The server comprises at least one processor, a memory storing executable instructions, a network interface, and a non-transitory storage apparatus that stores schema information and configuration data. The terminal comprises at least one processor, a display apparatus, a sound output apparatus, and an input apparatus such as a microphone, a keyboard, or a touch panel. The user interacts with the terminal to issue data definition instructions in natural language.

The server executes a program that is stored in the memory and the storage apparatus. The program is implemented, for example, in a general-purpose programming language and uses software modules including a speech recognition client library, a natural language processing library, an emotion analysis library, a database client library, and a visualization library. In one implementation, the server uses a speech-to-text service conforming to a general cloud speech recognition API, a natural language processing toolkit comparable to a dependency-parsing framework, an emotion analysis engine comparable to a tone analysis service, a language model API that implements a generative AI model, a database client such as a structured query interface for a relational database or data warehouse, and a visualization toolkit comparable to a plotting or charting library.

The terminal acquires voice information or character information from the user and converts the acquired information into machine-readable data. When the user speaks, the terminal uses the microphone and an analog-to-digital converter to sample the voice signal at a predetermined sampling rate, store it in a buffer as a digital audio stream, and packetize the audio stream into a network message. When the user types, the terminal uses an input apparatus to acquire a character string and encodes the character string in a character encoding format. The terminal sends the machine-readable data, together with metadata such as a timestamp, a language code, and a device identifier, to the server over a communication network using a protocol such as HTTPS.

The server converts voice information into text by using a speech recognition processing module. In one example, the server transmits the digital audio stream to a speech recognition service, which applies an acoustic model and a language model to output a text sequence. The acoustic model is implemented as a neural network such as a convolutional-recurrent network or a transformer-based encoder trained on spectrogram features, and the language model is implemented as an n-gram model or a neural sequence model trained on transcribed speech corpora. The server receives the text sequence as a character string and normalizes the string by applying case normalization, whitespace normalization, and numeral standardization. When the terminal has transmitted a text input, the server uses the text input directly and bypasses the speech recognition module.

The server performs natural language processing on the text representing the data definition instruction. The server uses a natural language processing library that provides tokenization, part-of-speech tagging, syntactic dependency parsing, and named entity recognition. The server converts the text into a sequence of tokens, assigns part-of-speech tags to the tokens, and constructs a dependency tree that represents grammatical relations between tokens. The server extracts a target index, an aggregation unit, and an extraction condition from the dependency tree and named entities. For example, when the user utters “What products are frequently purchased by male customers in their thirties?”, the server extracts “products” as a target index, “male customers in their thirties” as an extraction condition involving demographic attributes, and identifies that a frequency-based aggregation is implied.

The server maps the extracted linguistic information to schema information stored in the storage apparatus. The schema information describes tables, columns, data types, and relations in a data management system such as a relational database or a data warehouse. The server uses a mapping table that associates domain phrases (such as “sales”, “monthly”, “age group”, “gender”, “product”) with corresponding attributes (such as a column “sales_amount”, a column “month”, a column “age_group”, a column “gender”, a column “product_id”) and with table identifiers (such as “sales_table”, “purchase_table”). The server thereby generates an intermediate semantic representation that specifies the target index, aggregation unit, and extraction condition in terms of the actual schema.

The server estimates emotion information from the user's input by performing emotion analysis processing. The server uses an emotion analysis module that takes the text and, in some embodiments, acoustic features derived from the voice signal. The emotion analysis module implements a classifier, for example a neural network classifier that uses a bidirectional recurrent architecture or a transformer-based encoder, trained on labeled data containing user utterances annotated with emotion labels such as “urgent”, “neutral”, “detailed”, and “frustrated”. The input features for the classifier include token embeddings for text tokens and prosodic features such as pitch, energy, and speech rate for voice signals. The classifier outputs probability values for each emotion category. The server selects an emotion label when the corresponding probability exceeds a threshold, for example detecting “urgent” when the probability for urgency is above a predetermined value, or detecting “detailed” when phrases such as “in detail” appear in the text and the classifier output indicates a desire for more information.

The server constructs a prompt sentence for a generative AI model on the basis of the semantic representation and the emotion information. The server uses a template system that combines fixed text fragments with variable parts derived from the extracted target index, aggregation unit, extraction condition, database type, and emotion. For example, the server may construct a prompt sentence:

“Convert the following natural language query to SQL: What products do men in their 30s often buy?” or

“Quickly generate an efficient SQL query (relational database syntax) that returns the monthly sales trend. Natural language request: I need to know the monthly sales trends urgently.” or

“Convert the following natural language query to a detailed SQL query: I want to know in detail what kinds of products customers in their 20s are purchasing.”

In some embodiments, the server appends schema hints to the prompt sentence, such as:

“Use table sales_table with columns month and sales_amount.” or

“Use table purchase_table with columns age_group, gender, product_id.”

The server thereby encodes not only the user's natural language text but also explicit schema constraints and control directives related to emotion (such as an instruction to favor efficiency or detail) into the prompt sentence.

The server inputs the prompt sentence to a generative AI model, which is implemented as a language model, such as a transformer-based neural network trained on large-scale text data including programming language code and database query language statements. The generative AI model maintains a set of parameters (weights) learned by minimizing a loss function, such as cross-entropy between predicted token distributions and training sequences, using an optimization algorithm such as stochastic gradient descent with adaptive moment estimation. The generative AI model uses token embeddings and positional encodings as input features, and processes the sequence of prompt tokens through multiple layers of self-attention and feedforward networks to produce a probability distribution over next tokens. The server constrains the output by limiting the vocabulary or by using system-level instructions to obtain an output that consists only of a structured query language query without explanatory text.

The server receives the generated structured query language query from the generative AI model and stores it in memory. The server then verifies the generated query using a query validation module. The query validation module parses the query string into a syntax tree using a structured query language parser, enumerates referenced tables and columns, and compares them with the schema information stored in the storage apparatus. When a mismatch is detected, such as a nonexistent column or table name, the server modifies the query by replacing the invalid identifier with a valid one using the mapping table, or by rewriting problematic clauses. The server can also invoke a lightweight rule engine that enforces constraints on aggregation, such as adding missing group-by columns when an aggregate function is used.

The server adjusts at least one of an aggregation granularity, an extraction range, and a processing load of the structured query language query based on the emotion information. When the emotion is “urgent”, the server reduces processing load by increasing the aggregation granularity (for example, aggregating by month instead of by day), applying a time filter to limit data to a shorter period, or limiting the number of returned rows by adding a limit clause. When the emotion is “detailed”, the server decreases aggregation granularity to provide more detailed results (for example, aggregating by day or by customer group), extends the extraction range to include more attributes (for example, adding category information or region information), or retains detailed grouping in the group-by clause. The server performs these adjustments by programmatically editing the parsed query tree and regenerating the textual representation of the structured query language query. This dynamic adjustment mechanism is not a mere automation of human query editing, because the server uses emotion-aware non-linear rules and schema-based constraints encoded in the validation module to apply transformations that a standard query optimizer does not perform.

The server transmits the adjusted structured query language query to a data management system via a database client library. In one implementation, the data management system is a relational database management system or a column-oriented data warehouse. The server opens a connection using a driver, sends the query string, and receives execution result data as a set of records. The data management system performs internal operations such as logical plan generation, join ordering, index selection, caching, and physical execution, and returns only the requested aggregated data instead of raw detail records, thereby reducing network transfer and memory consumption on the server.

The server applies aggregation processing, sorting processing, and visualization processing to the execution result data. The server uses a data processing library such as a tabular data processing toolkit to convert execution result data into an internal table representation. The server then computes additional metrics, such as percentages, rankings, and moving averages, by executing vectorized operations on columns. This approach improves computational efficiency compared to naive row-by-row loops, because the operations are implemented in optimized, low-level routines that leverage processor caching and vector instructions.

The server uses a visualization library that can generate chart data structures or images such as bar charts, line charts, and tables. The server selects a display format and a display detail level based on the emotion information and on the dimensionality of the execution result data. For example, when emotion is “urgent”, the server generates a single time-series line chart with minimal labels and a small number of points to minimize rendering time and cognitive load. When emotion is “detailed”, the server generates multiple charts, such as a bar chart by product, a stacked bar chart by age group, and a table including underlying aggregated values. The server structures the visualization output as graphical information or tabular information, for example as an image buffer, a vector graphics description, or a chart specification, and sends it to the terminal.

The terminal receives the formatted graphical information or tabular information and outputs it to the user. The terminal uses its display apparatus to render visual content and its sound output apparatus when audio output is required. The terminal may execute a lightweight rendering application that interprets the chart specification and uses a client-side graphics library to draw the chart on the display. This separation of responsibilities reduces the server load for graphical rendering and reduces network bandwidth usage by sending only high-level chart data instead of full-resolution images when appropriate.

The system improves computer technology in several ways. Because the server constructs a prompt sentence that encodes schema constraints and emotion-dependent directives, the generative AI model produces structured query language queries that are more likely to conform to the actual data management system. This reduces the number of failed queries and retries, thereby decreasing query compilation overhead and network round trips between the server and the data management system. The emotion-aware adjustment of aggregation granularity and extraction range is integrated into the query generation pipeline, not simply applied as a presentation filter. As a result, the data management system itself executes less costly queries for urgent requests and more informative queries only when the user explicitly signals a need for detail. This leads to reduced processor time and input/output operations at the storage layer, which is a concrete technical improvement.

In addition, the explicit validation and rewriting of the generated structured query language queries based on schema information constitutes a non-conventional control flow for a generative AI model. Instead of directly using model output, the server interposes a rule-based correction and emotion-dependent simplification or expansion stage. This hybrid of learned generation and symbolic post-processing improves both accuracy and efficiency of query execution, going beyond a mere replacement of human scripting with automated scripting. The generative AI model itself is configured to accept prompt sentences that include database-specific tokens and emotion-related tokens. During training or fine-tuning, the model is exposed to pairs of prompt sentences and corresponding valid structured query language queries. The server or an associated training system minimizes an error function such as cross-entropy over the sequence of tokens by updating model weights using gradient-based optimization. Data augmentation techniques such as paraphrasing of natural language instructions, synonym replacement, and controlled insertion of emotion tokens (for example, tokens representing “urgent” or “detailed”) are used to increase robustness. Consequently, the model learns to associate emotion tokens with query complexity patterns and to handle schema-aware instructions, resulting in more predictable and controllable outputs.

The emotion analysis module uses a distinct training process. A labeled dataset of user utterances and text inputs with annotated emotion categories is used. The server trains the classifier by extracting features such as token embeddings computed from a pre-trained language encoder, and prosodic features computed from audio signals. A loss function such as categorical cross-entropy is minimized by adjusting the weights of the classifier using backpropagation. The trained classifier can then run in real time on the server, providing emotion labels with high accuracy and low latency. This technical arrangement enables the server to incorporate emotion information into the query generation pipeline without substantial overhead.

In additional embodiments, the server can use alternative architectures for the generative AI model, such as encoder-decoder models or mixture-of-experts models, and can employ different optimization policies for adjusting aggregation granularity, such as estimating query cost using a cost model and automatically selecting a plan that satisfies a latency target for urgent requests. The terminal can be implemented as a mobile device, a desktop computer, or a head-mounted display device, and the data management system can be an on-premises database, a cloud-based data warehouse, or a distributed file system with a query engine. In all of these embodiments, the server, the terminal, and the data management system cooperate to implement a technical system in which a generative AI model operates under explicit control of prompt sentences, schema-based validation, and emotion-aware query adjustment. This configuration provides a concrete improvement to the functioning of the computer system itself by reducing query failures, accelerating responses to urgent requests, improving the precision of detailed analyses, and optimizing the use of processing, memory, and communication resources.

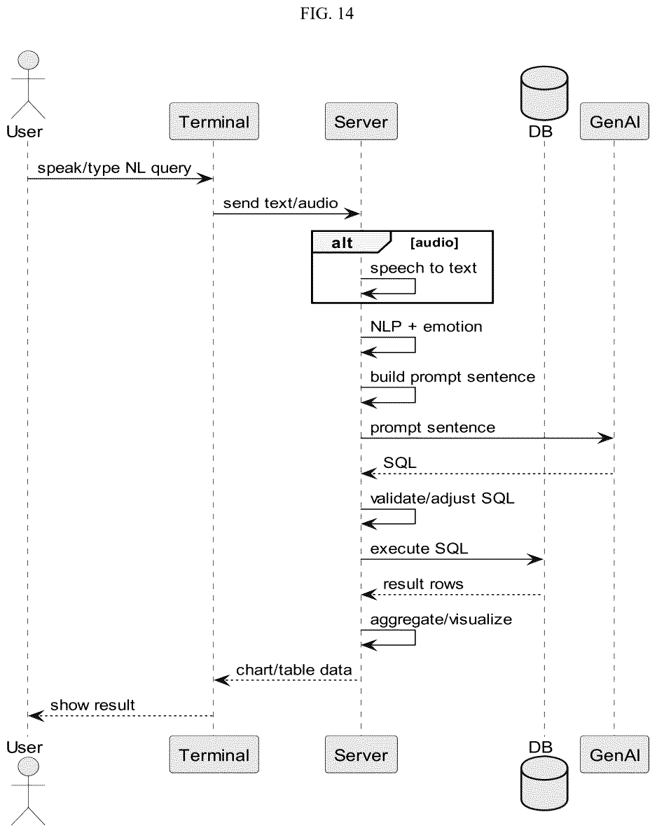

The following describes the processing flow using FIG. 14.

Step 1:

User operates the terminal and inputs a data definition instruction in natural language.

User provides the instruction either as voice (spoken into a microphone) or as text (typed on a keyboard or touch panel).

Input: Human speech sound or a text string expressing a data definition instruction (for example, “What products do men in their 30s frequently purchase?” or “I need to quickly see the monthly sales trends.”).

Output: Raw analog voice signal or a raw text string on the terminal.

Step 2:

Terminal acquires the user's input and converts it into machine-readable data.

Terminal samples the analog voice signal using an analog-to-digital converter to produce a digital audio stream, or encodes the typed characters using a character encoding scheme.

Terminal packages the machine-readable data with metadata such as timestamp, language code, and device identifier into a message.

Input: Raw analog voice signal or raw text string from the user.

Output: Digital audio data or encoded text data with metadata, ready for transmission to the server.

Step 3:

Terminal transmits the machine-readable data to the server via a communication network.

Terminal establishes a secure connection (for example, HTTPS) and sends a request message to an API endpoint on the server, embedding the audio or text payload and the metadata in the request body.

Input: Digital audio data or encoded text data with metadata.

Output: Network request containing the user's input delivered to the server.

Step 4:

Server receives the request and extracts the input payload.

Server reads the request body, separates the audio or text content from the metadata, and stores them in memory buffers for further processing.

Input: Network request containing digital audio data or encoded text data with metadata.

Output: In-memory representation of the audio or text data and an associated metadata structure on the server.

Step 5:

Server converts audio data to text when the user provided voice input.

Server detects from the metadata that the payload is audio, and sends the digital audio data to a speech recognition service.

Server receives a transcription consisting of a character string and a confidence score, and normalizes the string (for example, removing extra spaces, standardizing numerals).

Input: Digital audio data and metadata (including language).

Output: Normalized text string representing the spoken data definition instruction.

Step 6:

Server determines the text to be used for downstream processing.

Server selects either the directly received text (when the user typed) or the transcribed text (when the user spoke), and stores this text as the canonical representation of the data definition instruction.

Input: Encoded text from the terminal and/or normalized text from the speech recognition service.

Output: Canonical text string representing the user's data definition instruction.

Step 7:

Server performs natural language processing to extract structured intent information.

Server uses a natural language processing library to tokenize the text, assign part-of-speech tags, and build a dependency parse tree.

Server detects key phrases and named entities that correspond to target indexes (for example, “Sales”), aggregation units (for example, “Monthly”), and extraction conditions (for example, “Men in their 30s”).

Input: Canonical text string.

Output: Intermediate semantic data structure describing target indexes, aggregation units, and extraction conditions extracted from the text.

Step 8:

Server maps extracted linguistic elements to database schema information.

Server consults a schema mapping table that relates domain terms to table names and column names, then replaces domain phrases with corresponding schema identifiers.

Server validates that referenced tables and columns exist by checking schema information stored in a storage apparatus.

Input: Intermediate semantic data structure and schema information.

Output: Schema-aware semantic representation including specific table identifiers, column identifiers, and filter expressions.

Step 9:

Server performs emotion analysis on the user's text (and optionally audio characteristics). Server applies an emotion classifier to the canonical text and, when available, to prosodic features derived from the audio signal to determine emotion categories such as “urgent” or “detailed”.

Server computes probabilities for each category and selects the dominant emotion label based on a threshold.

Input: Canonical text string and optionally derived audio features; classifier parameters.

Output: Emotion label (for example, “urgent”, “detailed”, “neutral”) and confidence values associated with the user's instruction.

Step 10:

Server constructs a prompt sentence for the generative AI model.

Server selects a template based on the semantic representation, schema information, and emotion label, and inserts variable parts such as table names, column names, and the original instruction text into the template.

Server may append explicit constraints or guidance (for example, “use table sales_table with columns month and sales_amount”) to steer the generative AI model.

Input: Schema-aware semantic representation, emotion label, and canonical text.

Output: Prompt sentence instructing the generative AI model how to generate a structured query language query.

Step 11:

Server refines the prompt sentence if schema constraints require additional detail.

Server analyzes the complexity of the requested operation (for example, number of dimensions and filters) and extends the prompt with instructions to include or exclude certain attributes or to favor performance.

Server may generate different prompt variants depending on emotion, such as a simpler prompt for urgent requests and a more explicit, detailed prompt for analytical requests.

Input: Initial prompt sentence, schema information, and emotion label.

Output: Final prompt sentence prepared for submission to the generative AI model.

Step 12:

Server sends the prompt sentence to the generative AI model and requests query generation.

Server encodes the prompt as tokens, sets generation parameters (for example, maximum length, temperature), and calls a language model API implemented on a computational backend.

Server receives a generated text sequence containing a structured query language query.

Input: Final prompt sentence and generation parameters.

Output: Raw generated text representing a structured query language query.

Step 13:

Server extracts the structured query language query from the generated text.

Server removes auxiliary formatting such as code fences or explanatory phrases, and isolates the part of the generated text that conforms to a structured query language grammar.

Input: Raw generated text from the generative AI model.

Output: Candidate structured query language query string.

Step 14:

Server parses and validates the candidate query against the schema.

Server uses a structured query language parser to build a parse tree, identifies all referenced tables and columns, and compares them with schema information in the storage apparatus.

Server detects invalid or missing identifiers and structural errors (for example, missing group-by columns for aggregate expressions).

Input: Candidate structured query language query and schema information.

Output: Parsed query tree, validation results, and a list of inconsistencies or errors, if any.

Step 15:

Server rewrites the query to correct inconsistencies and to align with system constraints.

Server replaces invalid table or column names with valid ones using the mapping table, inserts missing group-by columns, and adjusts function names when the database dialect requires it.

Server regenerates the textual query string from the modified parse tree.

Input: Parsed query tree, validation results, and schema mapping rules.

Output: Verified structured query language query string that conforms to the actual schema.

Step 16:

Server adjusts aggregation granularity, extraction range, and processing load based on emotion.

Server inspects the emotion label: for “urgent”, the server increases aggregation granularity (for example, from daily to monthly), narrows time ranges, and reduces the number of result rows with a limit clause; for “detailed”, the server decreases aggregation granularity, broadens attribute sets, and adds extra grouping dimensions.

Server edits the parse tree accordingly and regenerates the final query string after adjustment.

Input: Verified structured query language query and emotion label.

Output: Emotion-adjusted structured query language query optimized for either speed or detail.

Step 17:

Server sends the final structured query language query to the data management system for execution.

Server opens or reuses a database connection using a client driver, sends the query string, and initiates query execution.

The data management system creates an execution plan, executes relational operations, and returns the result set to the server.

Input: Emotion-adjusted structured query language query.

Output: Execution result data in the form of records or rows returned from the data management system.

Step 18:

Server converts the execution result data into an internal tabular structure.

Server loads the result rows into a table data structure, such as a column-oriented in-memory representation, and assigns appropriate data types to each column.

Server may perform basic data cleaning, such as removing null values or handling outliers, depending on configuration.

Input: Execution result data from the data management system.

Output: In-memory table representation suitable for further numeric and visual processing.

Step 19:

Server performs additional data computations for analysis.

Server calculates derived metrics such as totals, averages, ratios, and rankings using vectorized operations on the table columns.

Server groups the data by relevant dimensions (for example, product, month, age_group) and computes aggregated measures such as sum of sales or count of purchases.

Input: In-memory table representation of the raw result data.

Output: Processed analytical dataset containing computed measures and grouped data.

Step 20:

Server selects a visualization type and detail level based on the analytical dataset and the emotion label.

Server inspects the number of dimensions and rows, and the emotion label, then chooses an appropriate chart type, such as a line chart for time series or a bar chart for category rankings.

For urgent emotion, the server prefers one concise chart; for detailed emotion, the server may select multiple charts and a tabular view.

Input: Processed analytical dataset and emotion label.

Output: Visualization configuration specifying chart types, axes mappings, and level of detail.

Step 21:

Server generates graphical or tabular information according to the visualization configuration. Server uses a visualization library to transform the analytical dataset into chart data structures or render images, assigning colors, labels, and axes based on the configuration.

Server may generate an HTML fragment with embedded chart specifications or an image buffer representing the chart.

Input: Visualization configuration and processed analytical dataset.

Output: Graphical information (for example, chart images or chart specifications) and/or tabular information ready for client consumption.

Step 22:

Server packages the visualization output and sends it to the terminal.

Server constructs a response message including the graphical information or tabular information, any summary text, and necessary metadata such as chart identifiers or scaling information.

Server transmits the response over the network to the terminal using a communication protocol.

Input: Graphical information and/or tabular information and associated metadata.

Output: Network response carrying visualization data to the terminal.

Step 23:

Terminal receives the response and renders the visualization for the user.

Terminal parses the received data, reconstructs charts from chart specifications or decodes image buffers, and displays them on the display apparatus; optionally, the terminal plays back audio summaries via the sound output apparatus.

Terminal may allow the user to interact with the visualization, such as selecting data points or scrolling through tables.

Input: Network response containing graphical information and/or tabular information.

Output: Visual and/or audio presentation of analytical results on the terminal.

Step 24:

User reviews the presented results and may issue a follow-up instruction.

User interprets the displayed charts or tables and, if more detail or another perspective is desired, provides an additional natural language instruction to the terminal.

Input: Visual or audio output from the terminal.

Output: New natural language data definition instruction that starts a new iteration of the processing flow.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

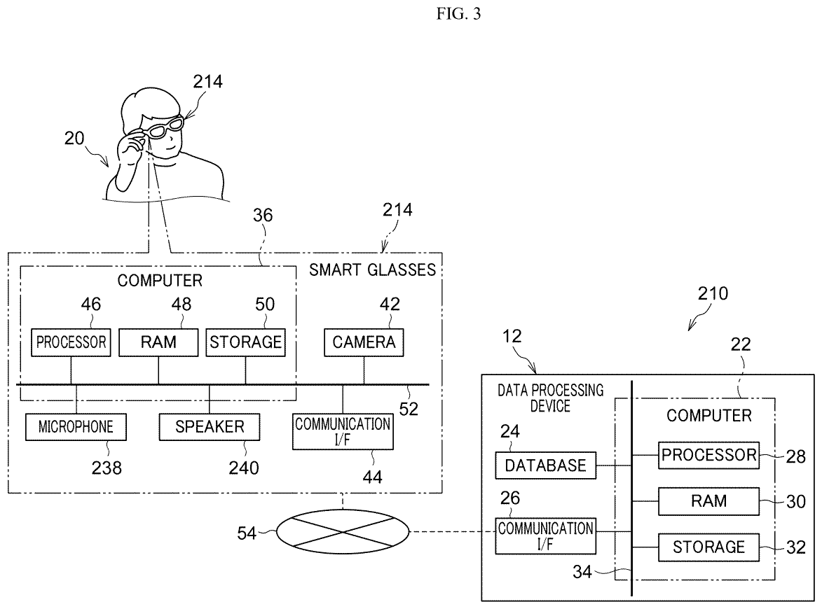

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

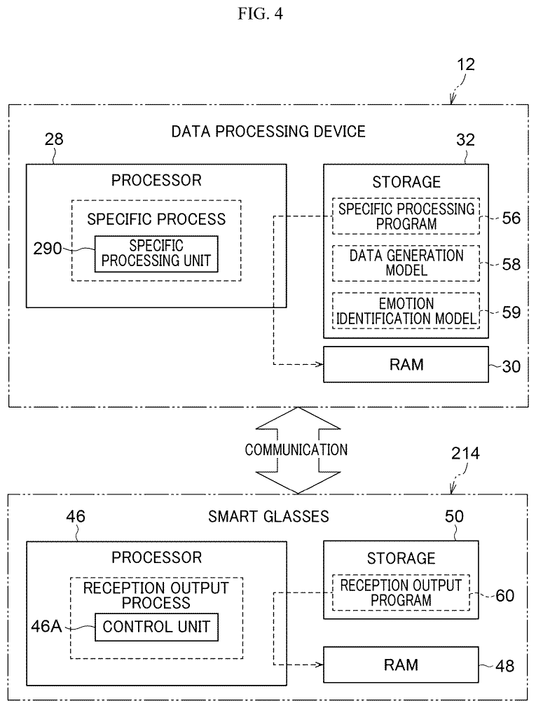

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

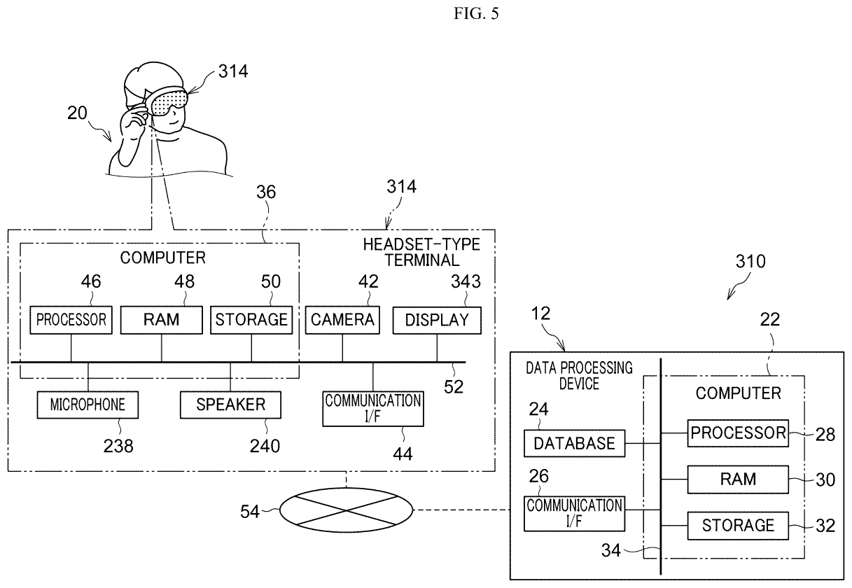

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

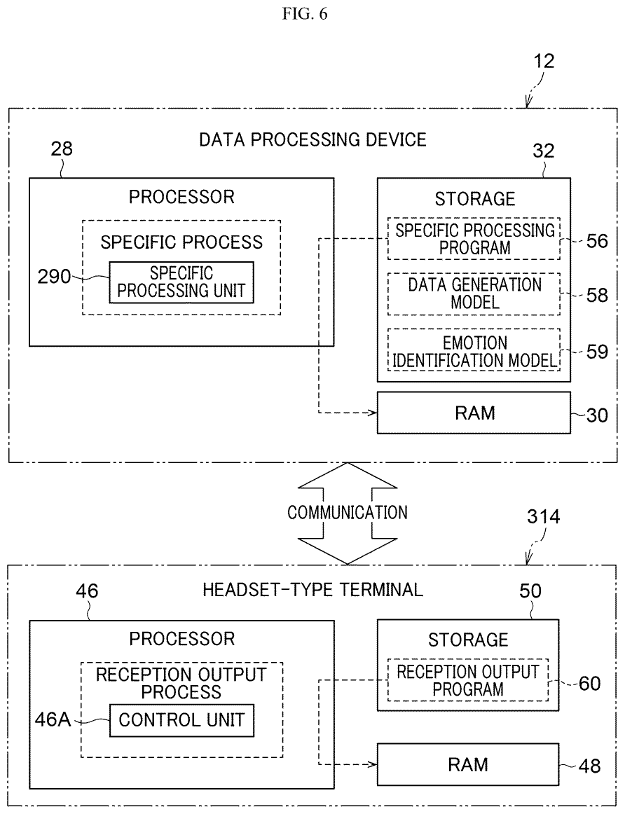

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

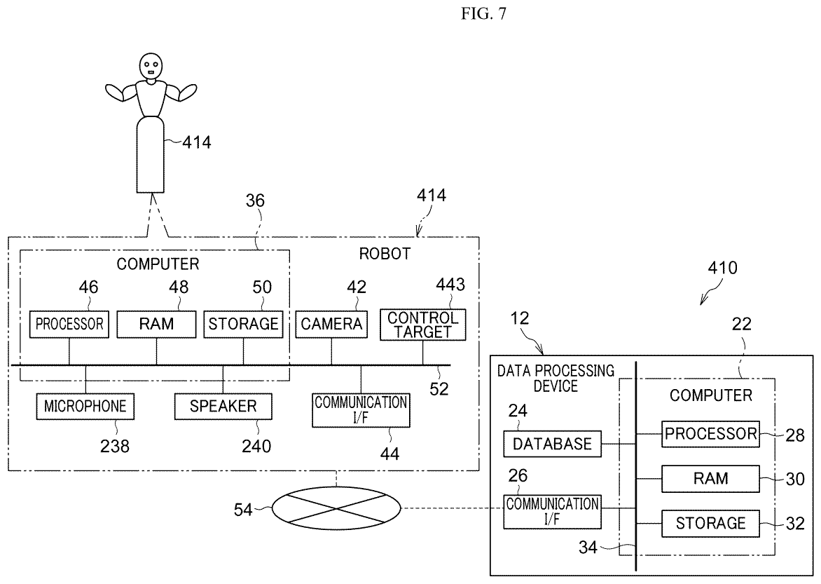

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

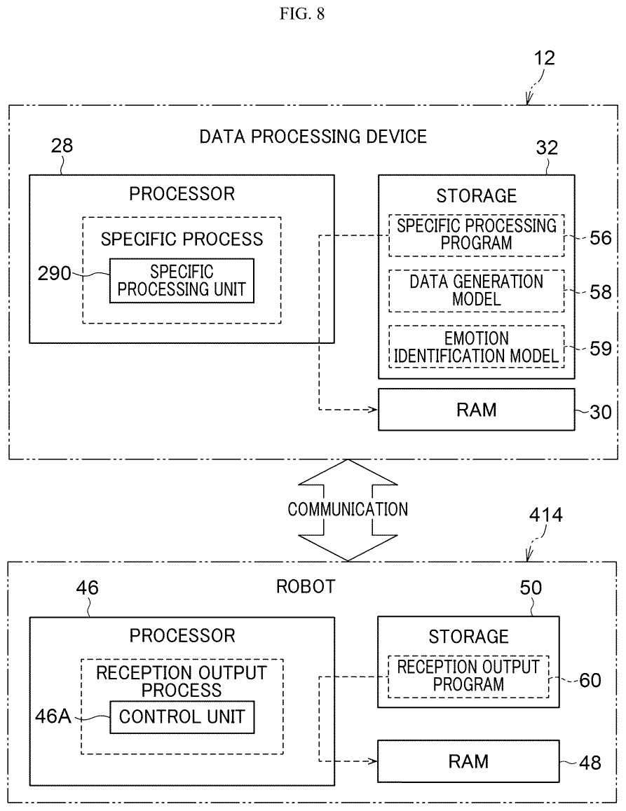

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naëve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

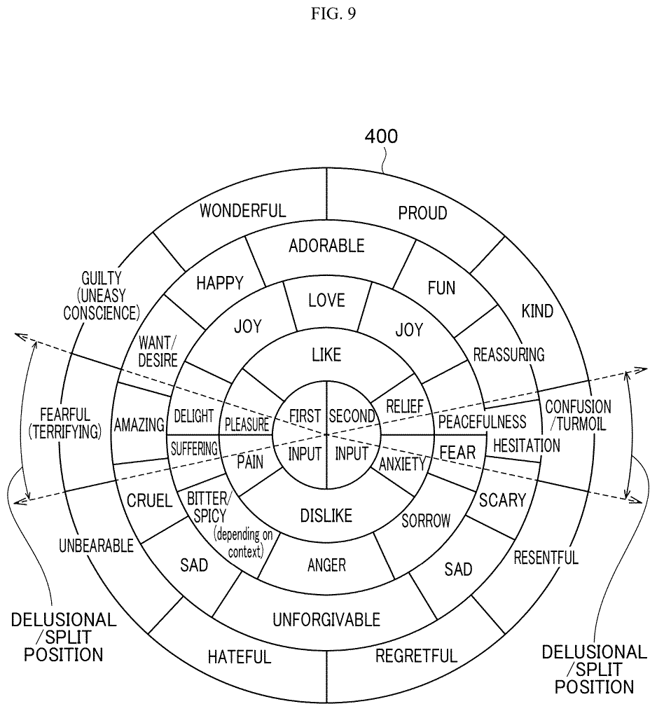

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

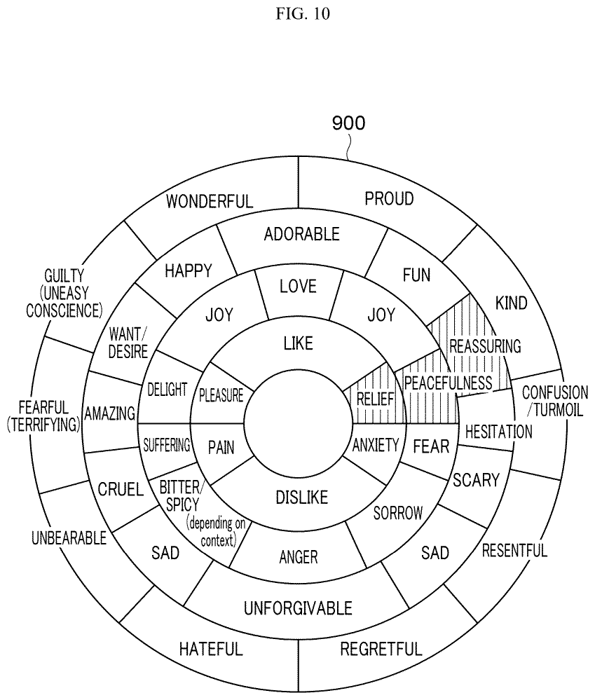

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive an information acquisition request in the form of speech from a user,
convert a voice of the user into a discrete numerical signal from a time-continuous signal by using an audio input apparatus,
transmit the converted numerical signal to a processing apparatus via a communication path,
apply speech recognition processing to the numerical signal in the processing apparatus and convert the numerical signal into character-string information by using natural language processing technology,
generate a prompt sentence based on the character-string information and data structure information stored in a storage apparatus, the prompt sentence being used to convert the character-string information into a data inquiry command,
input the prompt sentence into a generative AI model and cause the generative AI model to generate an inquiry statement including the data inquiry command corresponding to the character-string information,
inspect the inquiry statement to detect existence of a prohibited command and to check consistency of a reference target, and normalize the inquiry statement based on an inspection result,
transmit the normalized inquiry statement to a query processing mechanism of a data accumulation apparatus, and cause the query processing mechanism to execute the inquiry statement to perform aggregation processing or search processing,
analyze a processing result acquired from the data accumulation apparatus and convert the processing result into tabular information or a graph display structure,
transmit the converted processing result to a display apparatus via the communication path and cause the display apparatus to present the converted processing result as visual information, and
analyze emotional feature quantities extracted from the speech of the user and, based on the emotional feature quantities, adjust content of the prompt sentence or generation conditions of the inquiry statement by the generative AI model.

### Supplementary 2

The system according to supplementary 1,
wherein the processor is configured to
receive an information acquisition request in the form of character information from the user,
analyze the character information by using natural language understanding technology,
generate the prompt sentence based on an analysis result and the data structure information, and input the prompt sentence into the generative AI model to cause the generative AI model to generate the data inquiry command.

### Supplementary 3

The system according to supplementary 1,
wherein the processor is configured to
control the display apparatus to display the processing result, the data inquiry command, and the character-string information in combination, receive an additional input from the user with respect to a display result as a new information acquisition request, and regenerate the prompt sentence and the data inquiry command by using the additional input.

### Application Example 1

### Supplementary 1

A system comprising a processor,
wherein the processor is configured to
receive, from a user, a data definition instruction by voice, convert the user's voice into a digital audio signal by using an audio input device provided in a wearable information display apparatus, and transmit the digital audio signal to a server via a communication network,
convert, in the server, the digital audio signal into character information by executing a speech recognition information processing program, and apply a natural language processing information processing program to the character information to generate text data representing the data definition instruction,
analyze, in the server, the text data, construct a prompt sentence for generating a database query, input the prompt sentence into a generative AI model, and generate a corresponding structured query language (SQL) query,
validate, in the server, the generated SQL query by checking for prohibited expressions, consistency of referenced data structures, and syntactic correctness, and, when necessary, add constraint conditions to the prompt sentence and cause the generative AI model to regenerate the query,
transmit, in the server, the validated SQL query to an information storage apparatus, execute the SQL query by using a query processing function of an information management system, and acquire a query result,
execute, in the server, data processing on the acquired query result by using an information processing program including at least one of time-series completion, aggregation processing, numerical transformation, and formatting into a visualization structure, and convert the query result into visualization data in a structured information format,
transmit, in the server, the visualization data to the wearable information display apparatus via the communication network,
perform, in the wearable information display apparatus, graphic display processing based on the received visualization data, and display business indicators including at least a transition of sales information and category-wise aggregation as visual information superimposed on a display unit,
accept, from the user, additional input via the wearable information display apparatus, the additional input including at least one of an additional voice instruction and a gaze operation instruction, and, in the server, analyze the additional input in combination with the text data and a query history, update the prompt sentence to be input to the generative AI model, generate a new SQL query, and perform interactive query control that sequentially updates the query result, and
record, in the server, at least one of the prompt sentence, the generated SQL query, and attribute information related to the query result as history information, and update at least one of configuration rules of the prompt sentence and query validation conditions based on the history information so as to improve query generation processing by the generative AI model.

### Supplementary 2

The system according to supplementary 1,
wherein the processor is configured to generate, in the server, the prompt sentence by explicitly adding, to the prompt sentence, constraints related to at least one of a target data structure, attribute names, aggregation conditions, and an output format, based on the character information obtained by speech recognition processing and the history information, and to input the prompt sentence into the generative AI model to generate an SQL query specialized for a business use.

### Supplementary 3

The system according to supplementary 1,
wherein the processor is configured to control the wearable information display apparatus so that, in accordance with multiple types of visualization data received from the server, at least one of time-series display, category-wise aggregation display, and comparative display is arranged as a virtual screen in a spatial layout, and, in response to the additional voice instruction or the gaze operation instruction from the user, a display mode or an arrangement of the virtual screen is switched.

### Example 2

### Supplementary 1

A system comprising a processor,
wherein the processor is configured to
receive, from a terminal, an information definition instruction expressed in natural language by a user, acquire the information definition instruction as character information via an input device of the terminal, and receive the character information transmitted from the terminal through a communication network,
generate a prompt sentence including the information definition instruction, structure the prompt sentence as input data for a generative AI model, and supply the prompt sentence to the generative AI model,
analyze, by using the generative AI model, the prompt sentence so as to interpret an intention and a condition contained in the information definition instruction, and generate a database query in a structured query language corresponding to the information definition instruction,
inspect the generated database query, determine whether the database query conforms to an allowed logical structure and to a data structure stored in a storage device, and, when necessary, modify the database query by adding a restriction condition,
transmit the inspected database query to a data storage device, cause a query processing function provided in the data storage device to execute the database query, and acquire query result data comprising at least one of an aggregation result and an extraction result from the data storage device,
perform post-processing on the query result data, the post-processing including at least one of aggregation processing, ratio calculation processing, sorting processing, and conversion processing into a data structure for visualization, and format the query result data into display data,
transmit the formatted display data to the terminal, and cause the terminal to present the display data to the user via an output device in at least one of a tabular format and a graphical format,
and receive, via the terminal, an additional information definition instruction from the user, update the prompt sentence for the generative AI model based on at least one of the query result data and a previous database query, and repeatedly execute interactive query processing in natural language.

### Supplementary 2

The system according to supplementary 1,
wherein the processor is configured to generate the prompt sentence for the generative AI model by adding, to the information definition instruction, control information describing at least one of a table structure, an item attribute, and an aggregation policy of the data storage device as metadata, and to restrict a generation range and an output format of the database query by the generative AI model.

### Supplementary 3

The system according to supplementary 1,
wherein the processor is configured to input the query result data acquired from the data storage device to the generative AI model as an additional prompt, cause the generative AI model to generate at least one of a summary description and interpretive information for the query result data, and cause the terminal to present the at least one of the summary description and the interpretive information together with the query result data to the user.

### Application Example 2

### Supplementary 1

A system comprising a processor,
wherein the processor is configured to
receive a data definition instruction in natural language from a user, acquire voice information or character information of the user through an input apparatus, and convert the acquired information into machine-readable data,
analyze the machine-readable data by performing speech recognition processing and natural language processing so as to extract a target index, an aggregation unit, and an extraction condition included in the data definition instruction, and estimate emotion information of the user by performing emotion analysis processing,
construct a prompt sentence for generating a database query on the basis of an analysis result and the emotion information, input the prompt sentence to a generative artificial intelligence model, and generate a structured query language query,
verify the generated structured query language query by referring to schema information stored in a storage apparatus to check syntax and referenced objects, and adjust at least one of an aggregation granularity and a processing load of the structured query language query in accordance with the emotion information when necessary,
transmit an adjusted structured query language query to a data management system, cause the data management system to execute query processing, and acquire execution result data,
apply aggregation processing, sorting processing, and visualization processing to the execution result data, and, on the basis of the emotion information, control at least one of a display format and a display detail level to format the execution result data as graphical information or tabular information, and
transmit the formatted graphical information or tabular information to a terminal apparatus and present the formatted graphical information or tabular information to the user via a display apparatus or a sound output apparatus of the terminal apparatus.

### Supplementary 2

The system according to supplementary 1,
wherein the processor is configured to add logical structure information and attribute information of the data management system to the prompt sentence by using the target index, the aggregation unit, and the extraction condition extracted by the natural language processing, and to guide the generative artificial intelligence model such that the structured query language query obtained from the generative artificial intelligence model conforms to the data management system.

### Supplementary 3

The system according to supplementary 1,
wherein the processor is configured to, when the emotion information estimated by the emotion analysis processing indicates urgency, simplify at least one of the aggregation granularity and an extraction range of the structured query language query so as to reduce the processing load, and, when the emotion information indicates a request for detail, increase at least one of the aggregation granularity and a number of attributes of the structured query language query so as to enhance a detail level of the execution result data, by dynamically modifying the prompt sentence and the structured query language query.

What is claimed is:

1. A system comprising:
circuitry configured to:
receive, via a communication interface coupled to a packet-switched network, a voice signal from a terminal device, and convert the voice signal into a discrete numerical signal;
apply speech recognition processing to the discrete numerical signal to generate character-string information, and perform natural language processing on the character-string information to extract a target index, an aggregation unit, and an extraction condition from the character-string information;
generate a prompt sentence based on the character-string information and data structure information stored in a storage device, input the prompt sentence to a generative neural network model, and obtain from the generative neural network model an inquiry statement comprising a data inquiry command corresponding to the character-string information;
inspect the inquiry statement to detect existence of a prohibited command and to verify consistency of a reference target with the data structure information, and normalize the inquiry statement based on an inspection result;
transmit the normalized inquiry statement to a query processing mechanism of a data accumulation apparatus, cause the query processing mechanism to execute the normalized inquiry statement, and acquire a processing result; and
analyze emotional feature quantities extracted from the voice signal and adjust at least one of content of the prompt sentence or generation conditions of the generative neural network model based on the emotional feature quantities, and transmit a notification data packet comprising the processing result to the terminal device for presentation as visual information.

2. The system according to claim 1, wherein the circuitry is configured to convert the voice signal from a time-continuous analog signal into the discrete numerical signal by applying sampling at a predetermined sampling rate and quantization at a predetermined bit depth.

3. The system according to claim 2, wherein the speech recognition processing comprises applying an acoustic model to convert the discrete numerical signal into phoneme-level representations and applying a language model to the phoneme-level representations to generate the character-string information.

4. The system according to claim 3, wherein the natural language processing comprises tokenization, part-of-speech tagging, and named entity recognition applied to the character-string information to identify the target index, the aggregation unit, and the extraction condition as structured parameters.

5. The system according to claim 1, wherein the prompt sentence comprises a concatenation of the character-string information and metadata describing at least one of a table structure, an item attribute, or an aggregation policy of the data accumulation apparatus, and wherein the metadata restricts a generation range and an output format of the data inquiry command generated by the generative neural network model.

6. The system according to claim 5, wherein the generative neural network model comprises a transformer-based architecture including multiple self-attention layers and feed-forward layers, and wherein the circuitry is configured to control at least one of a temperature parameter or a top-k sampling threshold during generation of the inquiry statement.

7. The system according to claim 5, wherein the circuitry is configured to, when the inspection detects the prohibited command or an inconsistency with the data structure information, add a restriction condition to the prompt sentence and cause the generative neural network model to regenerate the inquiry statement.

8. The system according to claim 1, wherein the inspection comprises at least one of checking the inquiry statement for a prohibited operation type, verifying that each referenced data object exists in the data structure information, and validating syntactic correctness of the data inquiry command.

9. The system according to claim 8, wherein the normalization comprises at least one of rewriting a join condition, adding an index hint, or limiting a number of returned records based on a resource constraint stored in the storage device.

10. The system according to claim 1, wherein the circuitry is configured to perform post-processing on the processing result, the post-processing comprising at least one of aggregation processing, ratio calculation processing, sorting processing, time-series completion processing, or conversion processing into a visualization data structure comprising at least one of a tabular format or a graph display structure.

11. The system according to claim 10, wherein the circuitry is configured to control, based on the emotional feature quantities, at least one of a display format or a display detail level of the visualization data structure transmitted to the terminal device.

12. The system according to claim 1, wherein the emotional feature quantities comprise at least one of a fundamental frequency contour, an energy distribution, a speech rate, or a spectral feature extracted from the voice signal, and wherein the circuitry is configured to input the emotional feature quantities to an emotion classification model to estimate an emotional state of a user.

13. The system according to claim 12, wherein the circuitry is configured to, when the estimated emotional state indicates urgency, simplify at least one of the aggregation unit or an extraction range in the prompt sentence to reduce a processing load, and when the estimated emotional state indicates a request for detail, increase at least one of an aggregation granularity or a number of attributes in the prompt sentence.

14. The system according to claim 1, wherein the circuitry is configured to transmit to the terminal device the processing result, the data inquiry command, and the character-string information in combination, receive an additional input from the terminal device with respect to a displayed result as a new information acquisition request, and regenerate the prompt sentence and the data inquiry command based on the additional input and a query history.

15. The system according to claim 14, wherein the circuitry is configured to record at least one of the prompt sentence, the inquiry statement, and attribute information related to the processing result as history information in the storage device, and to update at least one of a configuration rule of the prompt sentence or a validation rule based on the history information.

16. The system according to claim 1, wherein the circuitry is configured to input the processing result to the generative neural network model as an additional prompt, and cause the generative neural network model to generate at least one of a summary description or interpretive information for the processing result, and to transmit the at least one of the summary description or the interpretive information together with the processing result to the terminal device.

17. The system according to claim 1, wherein the circuitry is configured to receive the character-string information as text input from the terminal device without voice conversion, analyze the character-string information by using natural language understanding processing, and generate the prompt sentence based on the character-string information and the data structure information.

18. A system comprising:
circuitry configured to:
receive, via a communication interface coupled to a packet-switched network, a voice signal from a terminal device, convert the voice signal into a discrete numerical signal, and apply speech recognition processing comprising an acoustic model and a language model to generate character-string information from the discrete numerical signal;
perform natural language processing including tokenization and named entity recognition on the character-string information to extract a target index, an aggregation unit, and an extraction condition, and generate a prompt sentence comprising the character-string information and metadata describing a table structure and an item attribute of a data accumulation apparatus;
input the prompt sentence to a generative neural network model comprising a transformer-based architecture and obtain an inquiry statement comprising a data inquiry command, inspect the inquiry statement for a prohibited command and for consistency with a data structure stored in a storage device, and normalize the inquiry statement;
transmit the normalized inquiry statement to a query processing mechanism of the data accumulation apparatus, acquire a processing result, and perform post-processing comprising at least one of aggregation processing, sorting processing, or conversion into a visualization data structure;
extract emotional feature quantities comprising at least one of a fundamental frequency contour, an energy distribution, or a speech rate from the voice signal, estimate an emotional state of a user, and adjust at least one of content of the prompt sentence or a display detail level of the visualization data structure based on the estimated emotional state; and
transmit, via the communication interface, a notification data packet comprising the visualization data structure to the terminal device for presentation.

19. The system according to claim 18, wherein the circuitry is configured to receive an additional input from the terminal device as a new information acquisition request, update the prompt sentence based on the additional input and a query history, regenerate the inquiry statement, and transmit an updated processing result to the terminal device.

20. A method comprising:
receiving, via a communication interface coupled to a packet-switched network, a voice signal from a terminal device, and converting the voice signal into a discrete numerical signal;
applying speech recognition processing to the discrete numerical signal to generate character-string information, and performing natural language processing on the character-string information to extract a target index, an aggregation unit, and an extraction condition from the character-string information;
generating a prompt sentence based on the character-string information and data structure information stored in a storage device, inputting the prompt sentence to a generative neural network model, and obtaining from the generative neural network model an inquiry statement comprising a data inquiry command corresponding to the character-string information;
inspecting the inquiry statement to detect existence of a prohibited command and to verify consistency of a reference target with the data structure information, and normalizing the inquiry statement based on an inspection result;
transmitting the normalized inquiry statement to a query processing mechanism of a data accumulation apparatus, causing the query processing mechanism to execute the normalized inquiry statement, and acquiring a processing result; and
analyzing emotional feature quantities extracted from the voice signal and adjusting at least one of content of the prompt sentence or generation conditions of the generative neural network model based on the emotional feature quantities, and transmitting a notification data packet comprising the processing result to the terminal device for presentation as visual information.
